(19) United States
(12) Patent Application Publication
(10) Pub. No.: US 2026/0172128 A1
(43) Pub. Date: Jun. 18, 2026

(54) METHOD AND APPARATUS FOR DATA LOGGING FOR BEAM MANAGEMENT IN MOBILE WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/333,604

(22) Filed: Sep. 19, 2025

(30) Foreign Application Priority Data
Dec. 15, 2024 (KR) 1020240186596
Sep. 17, 2025 (KR) 1020250133300

(51) Int. Cl. H04B 17/318; H04L 5/00

(52) U.S. Cl. CPC H04B 17/328; H04L 5/0044

(57) ABSTRACT

Aspects of the present disclosure are to enhance AIML based beam management in mobile communication system. The method of the terminal includes receiving from a base station a first downlink message that comprises a set of parameters for measurement logging; starting logging of a Reference Signal Reception Power (RSRP) of a resource of a second resource set at a regular time interval in case that a representative RSRP of a first resource set is above a first threshold during a specific time duration; receiving a second downlink message that comprises a parameter for logged measurement request; and transmitting a first uplink message in response to the second downlink message that comprises a set of logged measurement results and an indication on availability of logged data.

### CROSS-REFERENCE TO RELATED APPLICATION

This application claims priority to and the benefit of Korean Patent Application Nos. 10-2024-0186596, filed on Dec. 15, 2024, and 10-2025-0133300, filed on Sep. 17, 2025. Each of the above documents is hereby incorporated herein by reference in its entirety.

### BACKGROUND

### Technical Field

The present disclosure relates to AI/ML based beam management operation in wireless mobile communication system.

### Related Art

The rapid evolution of 5G New Radio (NR) networks has led to the widespread adoption of millimeter wave (mmWave) technology, which offers significant bandwidth and exceptionally high data rates. However, mmWave signals inherently suffer from substantial propagation attenuation and sensitivity to environmental factors, necessitating precise directional beamforming to maintain robust communication links. Beam management (BM), the process of aligning the transmitter and receiver beams, is thus a critical operation to ensure communication quality and link reliability.

Traditional BM techniques face significant challenges, particularly in scenarios involving user equipment (UE) with moderate to high mobility. These challenges include high signaling overhead, increased latency, and limited accuracy in beam selection. The conventional exhaustive beam sweeping methods to identify optimal beams result in inefficient use of network resources and elevated power consumption, ultimately degrading the user experience.

In this context, incorporating Artificial Intelligence (AI) and Machine Learning (ML) techniques into BM is essential to overcome these limitations. AI/ML-enabled BM can significantly improve beam prediction accuracy without increasing signaling overhead, thereby reducing latency and improving overall system efficiency. By enabling more intelligent, adaptive, and real-time beam selection, AI/ML-based solutions address the critical bottlenecks of legacy BM methods, especially in dynamic and high-mobility environments.

Therefore, there exists a strong need for innovative NR AIML Beam management techniques that leverage AI/ML algorithms to enhance beam alignment precision, minimize overhead, and reduce latency. Such advancements are vital to meet the performance requirements of next-generation wireless networks and to facilitate seamless, high-quality communications in diverse and challenging scenarios.

### SUMMARY

Aspects of the present disclosure are to enhance AIML based beam management in mobile communication system. The method of the terminal includes receiving from a base station a first downlink message that comprises a set of parameters for measurement logging; starting logging of a Reference Signal Reception Power (RSRP) of a resource of a second resource set at a regular time interval in case that a representative RSRP of a first resource set is above a first threshold during a specific time duration; receiving a second downlink message that comprises a parameter for logged measurement request; and transmitting a first uplink message in response to the second downlink message that comprises a set of logged measurement results and an indication on availability of logged data.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 1C is a diagram illustrating a Functional framework for AI/ML for NR air interface.

FIG. 2A is a diagram illustrating overall operation of the UE and network.

FIG. 2B illustrates RRC connection establishment procedure.

FIG. 2C illustrates RRC connection reconfiguration procedure.

FIG. 2D illustrates data transfer procedure in RRC_CONNECTED state.

FIG. 2E illustrates SSB.

FIG. 3A illustrates overall operation of the UE and network for AIML operation.

FIG. 3B illustrates overall operation of the UE and network for logging operation.

FIG. 3C illustrates logging campaign and logging sub-campaign.

FIG. 3D illustrates formats of MAC CEs.

FIG. 3E illustrates an example of measurement result processing.

FIG. 4 is a flow diagram illustrating operations of a terminal.

FIG. 5A is a block diagram illustrating the internal structure of a UE to which the disclosure is applied.

FIG. 5B is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
Terminal and UE and wireless device;
Information Element (IE) and set of parameters;
Parameter and field and IE;
Base station and GNB;
UAI and UEAssistanceInformation and UE assistance information message.

The integration of Artificial Intelligence (AI) and Machine Learning (ML) in New Radio (NR) systems necessitates efficient and effective data collection methods. These methods are crucial for training AI/ML models to optimize network performance, manage resources, and enhance user experiences. The following outlines various data collection techniques for NR systems:
>: Network Monitoring: Continuous monitoring of network parameters, such as signal strength, interference levels, and user mobility patterns, provides a rich dataset for AI/ML algorithms. This data is collected through network elements, including base stations and user equipment.
>: User Equipment Feedback: Data is gathered directly from user devices, including information on signal quality, data throughput, and application usage. This feedback helps in understanding user behavior and network performance from the end-user perspective.
>: Simulation and Emulation: Synthetic data is generated through network simulations and emulations, replicating various network conditions and user behaviors. This method allows for controlled data collection, enabling the training of AI/ML models under specific scenarios.
>: Environmental Sensing: Sensors deployed within the network environment collect data on physical conditions, such as temperature, humidity, and geographical features. This environmental data is used to understand its impact on network performance and optimize AI/ML models accordingly.
>: Historical Data Analysis: Historical network data is analyzed to identify patterns and trends. This retrospective analysis provides valuable insights for training AI/ML models, enabling predictive analytics and proactive network management.

The effective collection and utilization of data are fundamental to the successful implementation of AI/ML in NR systems. These methods ensure that AI/ML models are trained on comprehensive and representative datasets, leading to improved network performance and user satisfaction.

To enable efficient data collection, it is essential that UE starts and stops data transfer with sufficient controllability and self-estimation.

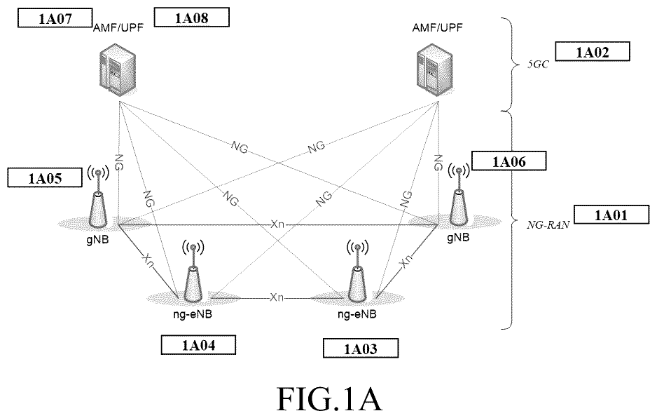

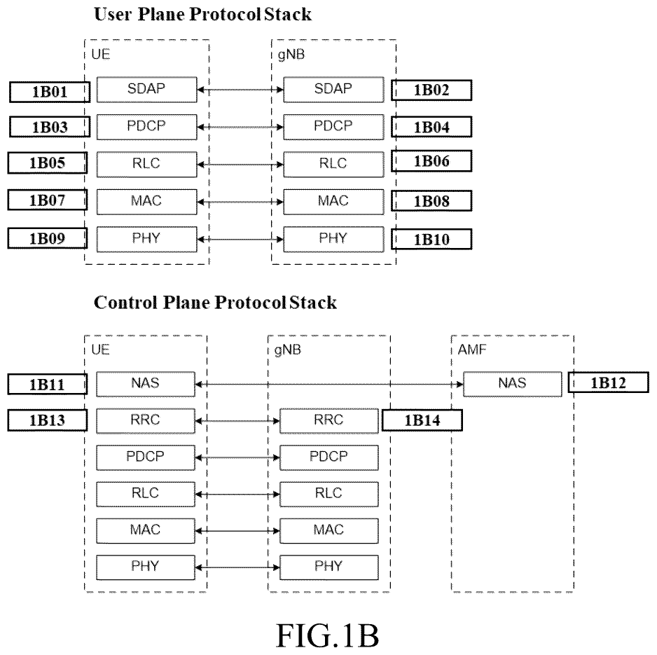

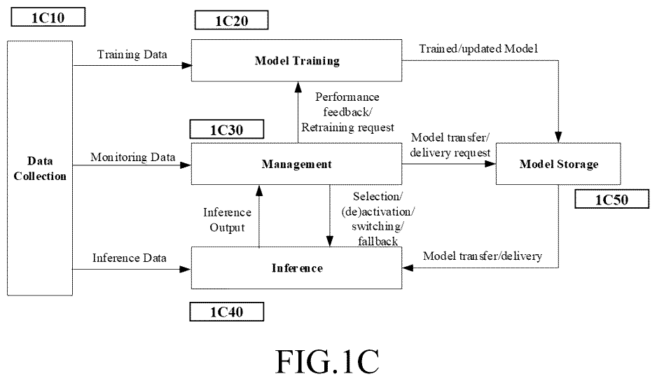

FIG. 1A is a diagram illustrating the architecture of an 5G system and a NG-RAN to which the disclosure may be applied.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

FIG. 1C illustrates functional framework of AI/ML for NR.

Data Collection 1C10 is a function that provides input data to the Model Training, Management, and Inference functions.
>: Training Data: Data needed as input for the AI/ML Model Training function.
>: Monitoring Data: Data needed as input for the Management of AI/ML Models or AI/ML functionalities.
>: Inference Data: Data needed as input for the AI/ML Inference function.

Model Training 1C20 is a function that performs AI/ML model training, validation, and testing which may generate model performance metrics which can be used as part of the model testing procedure. The Model Training function is also responsible for data preparation (e.g., data pre-processing and cleaning, formatting, and transformation) based on Training Data delivered by a Data Collection function, if required.
>: Trained/Updated Model: In case of having a Model Storage function, this is used to deliver trained, validated, and tested AI/ML models to the Model Storage function, or to deliver an updated version of a model to the Model Storage function.

Management 1C30 is a function that oversees the operation (e.g., selection/(de) activation/switching/fallback) and monitoring of AI/ML models or AI/ML functionalities. This function is also responsible for making decisions to ensure the proper inference operation based on data received from the Data Collection function and the Inference function.
>: Selection/(de) activation/switching/fallback: Information needed as input to manage the Inference function. Concerning information may include selection/(de) activation/switching of AI/ML models or AI/ML-based functionalities, fallback to non-AI/ML operation (i.e., not relying on inference process), etc.,
>: Model Transfer/Delivery Request: Used to request model(s) to the Model Storage function.
>: Performance feedback/Retraining request: Information needed as input for the Model Training function, e.g., for model (re) training or updating purposes.

1C40 Inference is a function that provides outputs from the process of applying AI/ML models or AI/ML functionalities to new data (i.e., Inference Data). The Inference function is also responsible for data preparation (e.g., data pre-processing and cleaning, formatting, and transformation) based on Inference Data delivered by a Data Collection function, if required.
>: Inference Output: Data used by the Management function to monitor the performance of AI/ML models or AI/ML functionalities.

Model Storage 1C50 is a function responsible for storing trained/updated models that can be used to perform the inference process.
>: Model Transfer/Delivery: Used to deliver an AI/ML model to the Inference function.

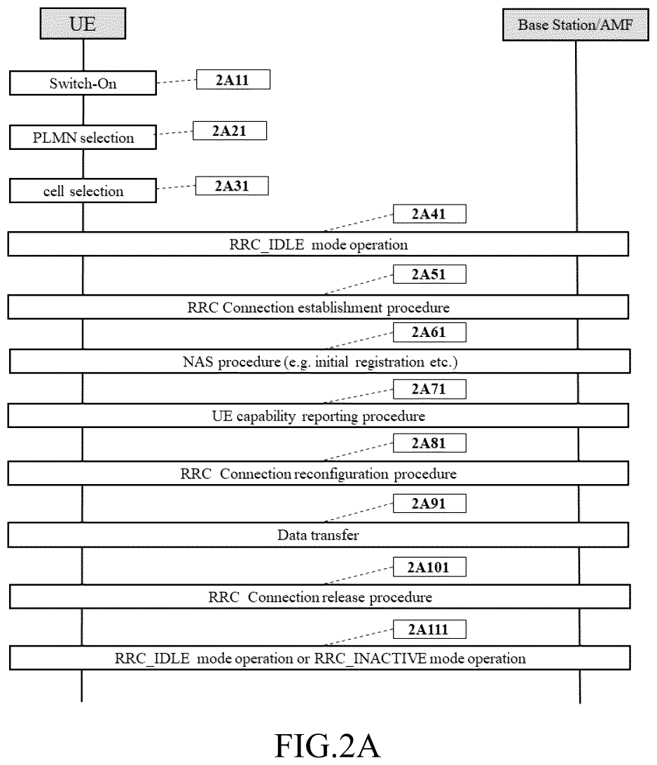

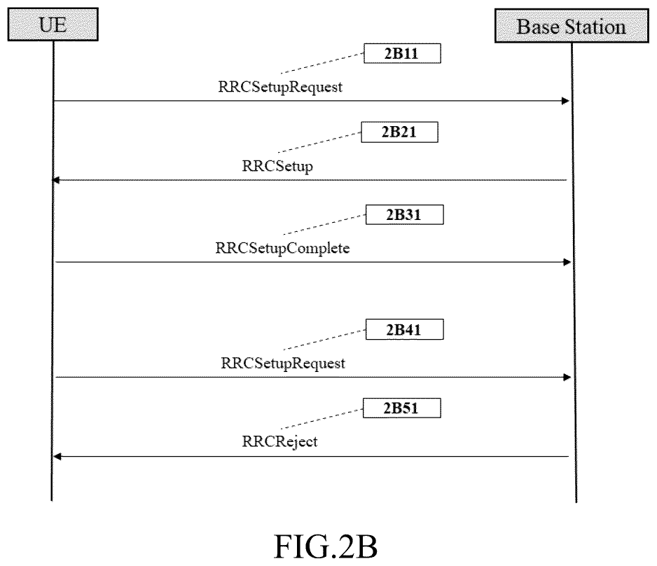

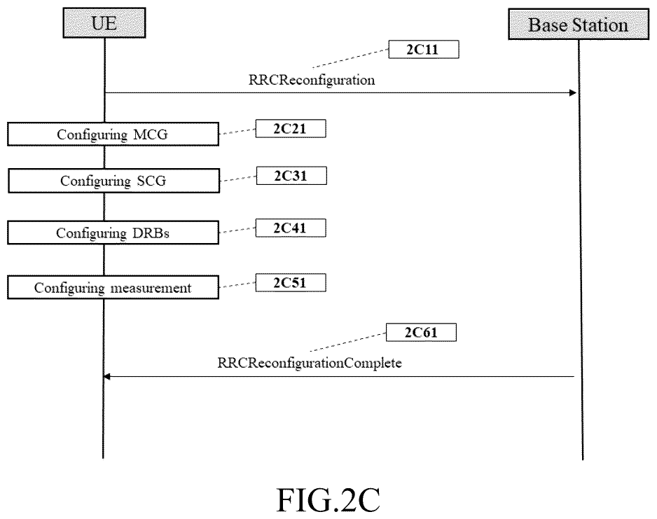

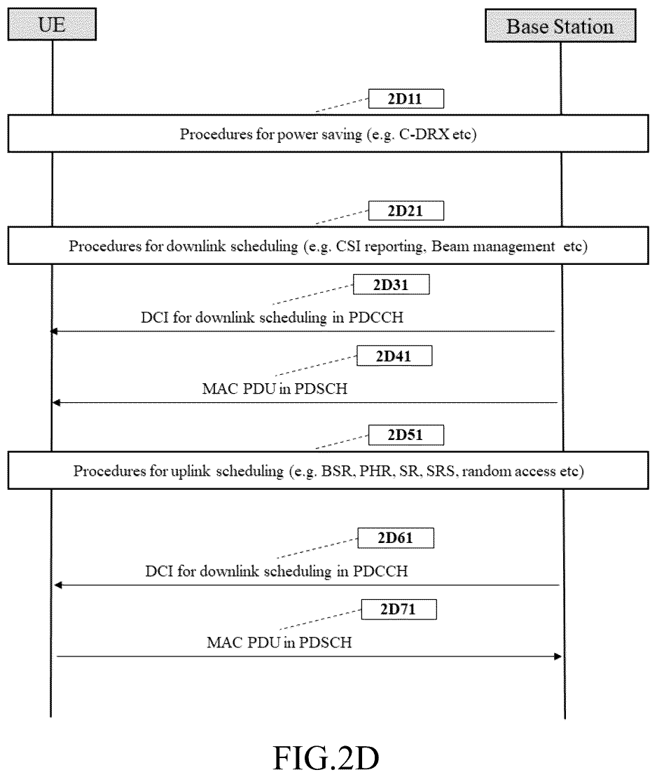

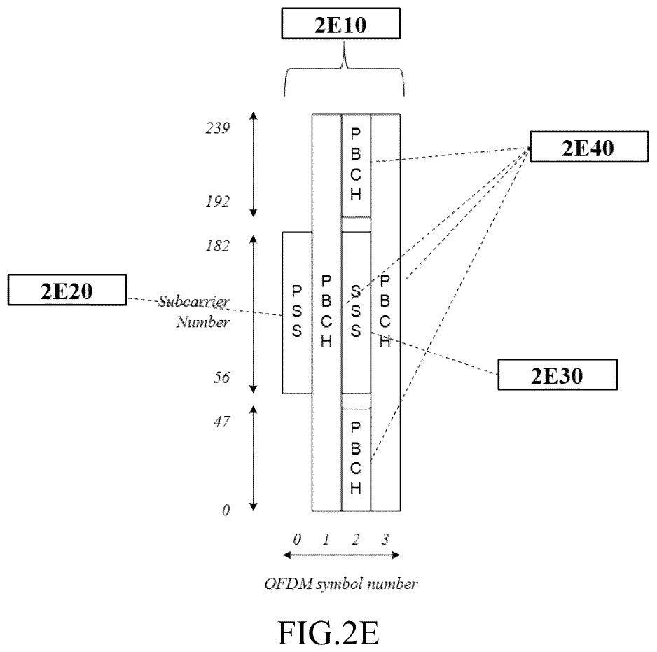

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
>1: transmission of RRCSetupRequest by the UE 2B11;
>1: reception of RRCSetup by the UE 2B21;
>1: transmission of RRCSetupComplete by the UE 2B31.

Unsuccessful RRC connection establishment procedure comprises:
>1: transmission of RRCSetupRequest by the UE 2B41;
>1: reception of RRCReject by the UE 2B51;

RRCSetupRequest comprises following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
>1: radioBearerConfig field containing a RadioBearerConfig IE;
>1: masterCellGroup field containing a CellGroupConfig IE.

RRCSetupComplete comprises following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

FIG. 2C illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprise following fields and IEs:
>1: rrc-TransactionIdentifier field contains a RRC-TransactionIdentifier IE;
>1: radioBearerConfig field contains a RadioBearerConfig IE;
>>2: radioBearerConfig field comprises configuration information for SRBs and DRBs via which RRC messages and user traffic are transmitted and received;
>1: secondaryCellGroup field contains a CellGroupConfig IE;
>>2: secondaryCellGroup field comprises configuration information for secondary cell group;
>>2: A cell group consists of a SpCell and zero or more SCells;
>>2: Cell group configuration information comprises cell configuration information for SpCell/SCell and configuration information for MAC and configuration information for logical channel etc;
>1: measConfig field contains a MeasConfig IE;
>>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2C21;
>1: perform the cell group configuration for SCG based on the received secondaryCellGroup 2C31;
>1: perform the radio bearer configuration based on the received radioBearerConfig 2C41;
>1: perform the measurement configuration based on the received measConfig 2C51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2D illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedure for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

The Synchronization Signal and PBCH block (SSB) 2E10 consists of primary synchronization signals (PSS) 2E20 and secondary synchronization signals (SSS) 2E30, PSS and SSS occupies 1 symbol and 127 subcarriers. PBCH 2E40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

In this disclosure, following terminologies are used.
# Associated ID (A-ID): An integer managed by a network entity such as GNB to keep the consistency of AIML operation. The A-ID represents scenario, RAN configuration and network conditions. UE and Network determine whether a AIML model/functionality is applicable based on the A-ID associated with the AIML model/functionality. UE may assume the similar properties of a DL Tx beam or beam set/list associated with the same associated ID. UE may assume the same number/order of DL Tx beams with the same associated ID. A-ID may be unique within a PLMN. An A-ID consists with PLMN-ID part and AMF-ID part and GNB-ID part and local identifier. The local identifier part may consist with cell-id part and cell-specific local identifier part. Alternatively, A-ID consists with OTT server ID part and local identifier part. The OTT server refers to network entity where AIML model training and AIML management function reside.

Instead of full A-ID, a short A-ID can be indicated in the DCI/MAC CE. The mapping between the full A-ID and the short A-ID can be explicitly indicated in the RRCReconfiguration message (for example. Alternatively, the mapping can be done based on a predefined rule (e.g. the last n bit of full A-ID is corresponding short A-ID; the part that are assigned by the base station (e.g. GNB-ID part+local identifier) is short A-ID; cell-specific local identifier field; the part that are assigned by the operator etc).
# Training profile information: Set of information for an AIML model that is used by UE to determine whether the AIML model is applicable or not. It comprises A-ID and time/frequency information related to trained resource (e.g. periodicity of Set A resource; periodicity of Set B resource; frequency region for Set A resource, frequency region for Set B resource etc.)

### # AIML Model Inference Operation:

## BM1: Spatial-domain Downlink beam prediction for Set A of beams based on measurement results of Set B of beams ## BM2: Temporal Downlink beam prediction for Set A of beams based on the historic measurement results of Set B of beams
# virtual CSI-RS (reference signal): CSI-RS resource that is used for AIML model inference operation. CSI-RS is not transmitted on the virtual CSI-RS resource. Virtual CSI-RS resource is configured by CSI resource configuration for which CSI resource type is set to a specific value (e.g. virtual/inference)
# measurement_based_CSI_reporting: CSI reporting that is configured with a CSI resource configuration that is used both for measurement and for channel state information determination.
# inference_based_CSI_reporting: CSI reporting that is configured with first CSI resource configuration for measurement and second CSI resource configuration for channel state information determination (e.g. AIML model inference). CSI report for inference_based_CSI_reporting contains channel state information for the second CSI resource configuration. It is equivalent to AIML based CSI reporting.
# Hybrid_CSI_reporting: CSI reporting that is configured with first CSI resource configuration for measurement/channel state information determination and second CSI resource configuration for channel state information determination only (e.g. AIML model inference). CSI report for Hybrid_CSI_reporting contains channel state information for the first CSI resource configuration and channel state information for the second CSI resource configuration.
# CSI: Channel State Information refers to information about the state of the communication channel between the base station (gNB) and the user equipment (UE). CSI may comprise Channel Quality Indicator (CQI), Precoding Matrix Indicator (PMI), Rank Indicator (RI), CSI-RS Resource Indicator (CRI), SS/PBCH Block Resource Indicator (SSBRI), Layer Indicator (LI) and L1-RSRP.
# AI/ML-enabled Feature: refers to a Feature where AI/ML may be used.
# AI/ML Model: A data driven algorithm that applies AI/ML techniques to generate a set of outputs based on a set of inputs.
# AI/ML model delivery: A generic term referring to delivery of an AI/ML model from one entity to another entity in any manner.
# AI/ML model Inference: A process of using a trained AI/ML model to produce a set of outputs based on a set of inputs.
# AI/ML model testing: A subprocess of training, to evaluate the performance of a final AI/ML model using a dataset different from one used for model training and validation. Differently from AI/ML model validation, testing does not assume subsequent tuning of the model.
# AI/ML model training: A process to train an AI/ML Model [by learning the input/output relationship] in a data driven manner and obtain the trained AI/ML Model (and associated AID) for inference.
# AI/ML model transfer: Delivery of an AI/ML model over the air interface in a manner that is not transparent to 3GPP signalling, either parameters of a model structure known at the receiving end or a new model with parameters. Delivery may contain a full model or a partial model.
# AI/ML model validation: A subprocess of training, to evaluate the quality of an AI/ML model using a dataset different from one used for model training, that helps selecting model parameters that generalize beyond the dataset used for model training.
# Data collection: A process of collecting data by the network nodes, management entity, or UE for the purpose of AI/ML model training, data analytics and inference.
# Federated learning/federated training: A machine learning technique that trains an AI/ML model across multiple decentralized edge nodes (e.g., UEs, gNBs) each performing local model training using local data samples. The technique requires multiple interactions of the model, but no exchange of local data samples.
# Functionality identification: A process/method of identifying an AI/ML functionality for the common understanding between the NW and the UE. Note: Information regarding the AI/ML functionality may be shared during functionality identification. Where AI/ML functionality resides depends on the specific use cases and sub use cases.
# Management instruction: Information needed to ensure proper inference operation. This information may include selection/(de) activation/switching of AI/ML models or AI/ML functionalities, fallback to non-AI/ML operation, etc.
# Model activation: enable an AI/ML model for a specific AI/ML-enabled feature.
# Model deactivation: disable an AI/ML model for a specific AI/ML-enabled feature.
# training-inference pair (TIP): It is a pair of AIML functionality/AIML model and an A-ID. It represents an AIML functionality/model which is trained under the circumstances represented by the AID. AIML is configured/activated/deactivated and resumed by TIP.
# applicable training-inference pair (AIML model): a TIP that is applicable at a given circumstances. A TIP of which AID and AIML function/model are available both in the UE and in the GNB.
# RRC-TransactionIdentifier: The RRC-TransactionIdentifier is a unique identifier for RRC transactions between the User Equipment (UE) and the network. The RRC-TransactionIdentifier is used, together with the message type, to identify specific RRC procedures or transactions. It helps in pairing request and response messages in RRC procedures, ensuring proper message handling and avoiding confusion between different ongoing procedures.
# training resource: resource collectively refers to resource for downlink reference signal resource and downlink reference signal transmitted/received on the resource. Training resource is resource configured/activated for AIML model training purpose.
# source training resource: source training resource is training resource for input beams.
# target training resource: target training resource is training resource for output beams.

Followings are used interchangeably:
# TIP and inference_based_CSI_report configuration and inference_based_CSI_reporting
# synchronous reconfiguration and reconfiguration with sync and cell level mobility and handover
# target cell and new SpCell and new PCell and target SpCell and target PCell
# AIML model and AIML function and AIML feature
# input beam and Set B beam and source beam and source training resource;
# output beam and Set A beam and target beam and target training resource;
# resource may mean a CSI-RS resource or a SSB.
# logging sample: group of beam indexes and group of calculated measured results
# logging campaign: group of logging sub-campaigns that are performed for a data logging session.
# logging sub-campaign: data logging activities that are performed during a sub-session. The sub-session starts when a specific event occurs and ends when a second specific event occurs.

Followings are used interchangeably:
# logging sample and sample and logging-sample and measurement sample;

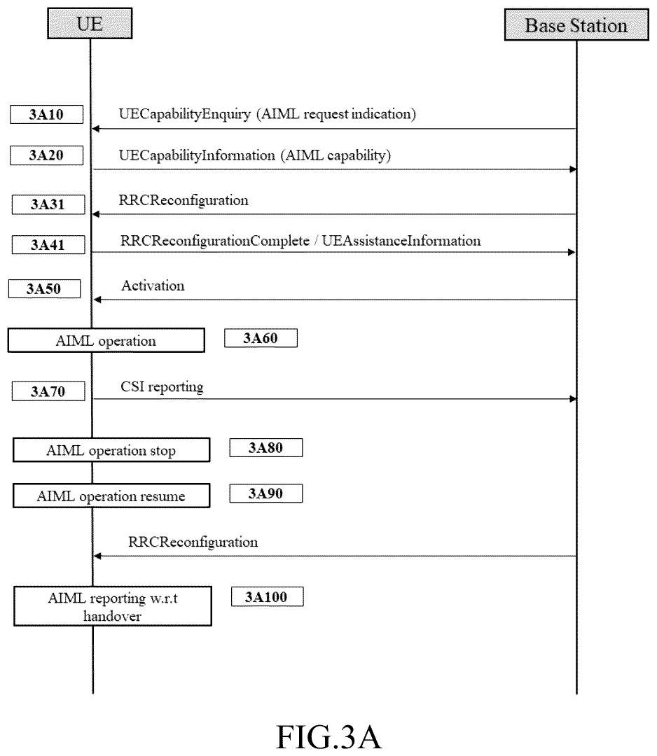

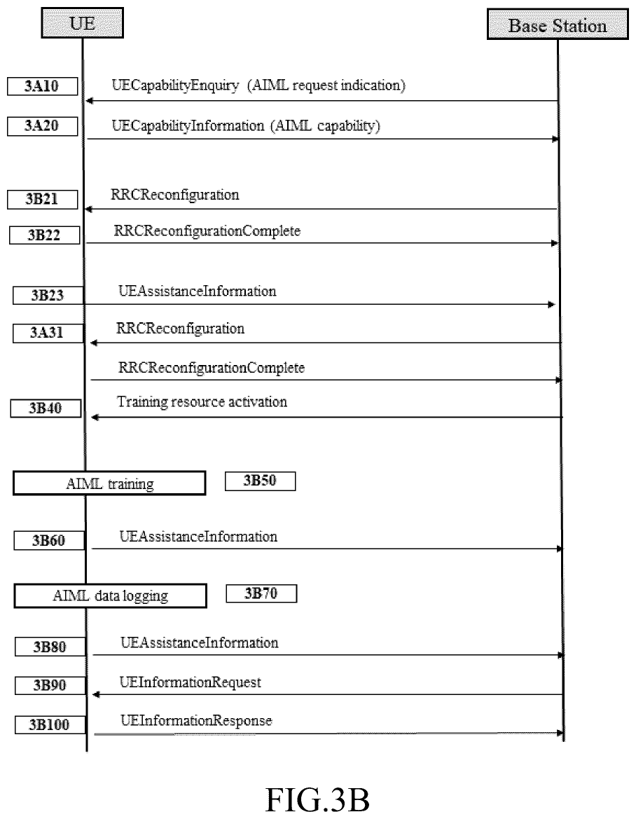

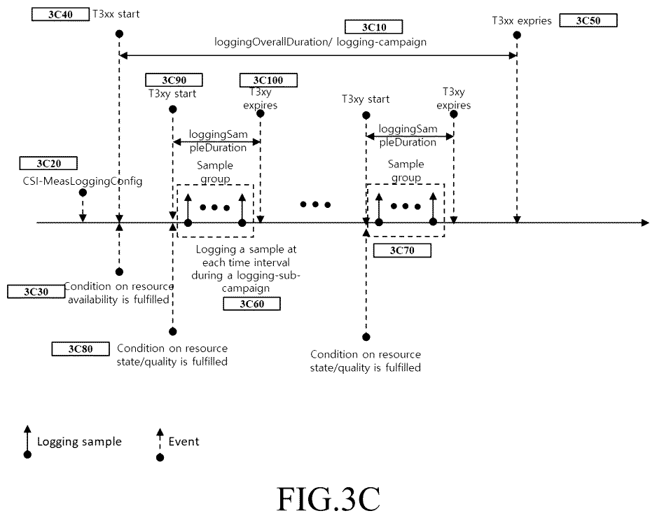

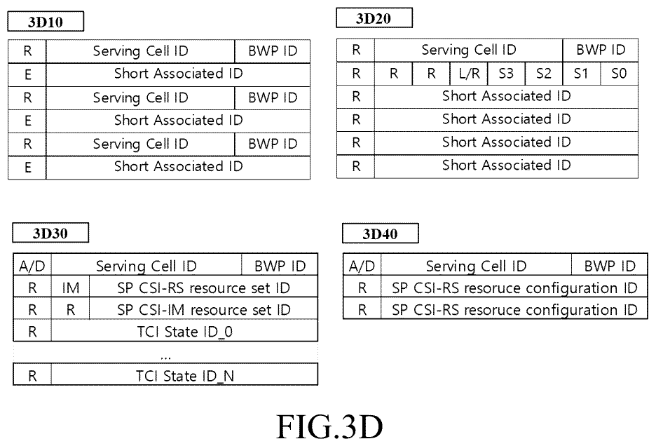

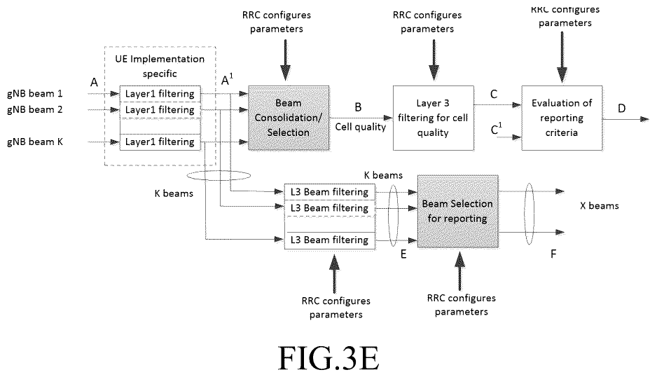

FIG. 3A illustrates operations of UE and GNB for AIML inference operation for beam management.

At 3A10, UE receives from GNB UECapabilityEnquiry message. The UECapabilityEnquiry message comprises information related to AIML capability. The UECapabilityEnquiry message comprises a UE-CapabilityRAT-RequestList. The IE UE-CapabilityRAT-RequestList is used to request UE capabilities for one or more RATs from the UE.

| | |
|---|---|
| UE-CapabilityRAT-Request ::= | SEQUENCE { |
| rat-Type | RAT-Type, |
| capabilityRequestFilter | OCTET STRING |

OPTIONAL, -- Need N
...
}

capabilityRequestFilter is information by which the network requests the UE to filter the UE capabilities. For rat-Type set to nr or eutra-nr: the encoding of the capabilityRequestFilter is defined in UE-CapabilityRequestFilterNR. rat-Type indicates the RAT type for which the NW requests UE capabilities.

| UE-CapabilityRequestFilterNR-v1910 ::= | SEQUENCE { |
|---|---|
| aimlRequest-r19 | ENUMERATED {true} |
| OPTIONAL, -- Need N | |
| nonCriticalExtension | SEQUENCE { } |

OPTIONAL
}

If the aimlRequest field is comprised in the UECapabilityEnquiry message, UE includes AIML related capability information in the UE-NR-Capability in the UECapability Information message.

At 3A20, UE transmits to GNB UECapabilityInformation message.

| | |
|---|---|
| UECapabilityInformation ::= | SEQUENCE { |
| rrc-TransactionIdentifier | RRC-TransactionIdentifier, |
| criticalExtensions | CHOICE { |
| ueCapabilityInformation | UECapabilityInformation-IEs, |
| criticalExtensionsFuture | SEQUENCE { } |

```
    }
  }
```

| | |
|---|---|
| UECapabilityInformation-IEs ::= | SEQUENCE { |
| ue-CapabilityRAT-ContainerList | UE-CapabilityRAT-ContainerList |

OPTIONAL,

| | |
|---|---|
| lateNonCriticalExtension | OCTET STRING |

OPTIONAL,

| | |
|---|---|
| nonCriticalExtension | SEQUENCE{ } |

```
OPTIONAL
  }
  The IE UE-CapabilityRAT-ContainerList contains a list of radio access technology
specific capability containers.
```

| | |
|---|---|
| UE-CapabilityRAT-Container ::= | SEQUENCE { |
| rat-Type | RAT-Type, |
| ue-CapabilityRAT-Container | OCTET STRING |

}

ue-CapabilityRAT-Container is container for the UE capabilities of the indicated RAT. The encoding is defined in the specification of each RAT:

For rat-Type set to nr, the encoding of UE capabilities is defined in UE-NR-Capability. For rat-Type set to eutra-nr, the encoding of UE capabilities is defined in UE-MRDC-Capability.

In case that UE-CapabilityRAT-Request with rat-Type set to NR was included in UECapabilityEnquiry message, UE generates UE-NR-Capability IE and includes it in UECapabilityInformation message.

The IE UE-NR-Capability is used to convey the NR UE Radio Access Capability Parameters. In case that the UE-CapabilityRAT-Request with rat-Type set to NR comprises aimlRequest field, UE includes aiml-Parameters field (comprising AIML-Parameters IE) in the UE-NR-Capability IE.

The IE AIML-Parameters is used to convey the subset of UE Radio Access Capability Parameters that apply to AIML integrated to NR. The IE may comprise:
# list of AIML functions that is controlled by RAN node (e.g. BM1, BM2 etc)
# list of IDs of AIML models per supported AIML function
# list of A-IDs per supported AIML model
# list of TIPs that are supported by the terminal

Based on the AIML-Parameters, GNB decides to configure some of AIML functions/models (e.g. specific AIML function/model for BM1). GNB includes related configuration parameters in RRCReconfiguration message. GNB transmits the RRCReconfiguration message to the UE.

At 3A31, UE receives from GNB RRCReconfiguration message. The RRCReconfiguration message configuration parameters for one or more serving cells. The message may comprise one or more ServingCellConfig IEs. The IE ServingCellConfig (set of configuration parameters for a serving cell) is used to configure (add or modify) the UE with a serving cell, which may be the SpCell or an SCell of an MCG or SCG.

```
  -- ASN1START
  -- TAG-SERVINGCELLCONFIG-START
```

| | |
|---|---|
| ServingCellConfig ::= | SEQUENCE { |
| tdd-UL-DL-ConfigurationDedicated | TDD-UL-DL-ConfigDedicated |
| initialDownlinkBWP | BWP-DownlinkDedicated |
| downlinkBWP-ToReleaseList | SEQUENCE (SIZE |

(1..maxNrofBWPs)) OF BWP-Id

| | |
|---|---|
| downlinkBWP-ToAddModList | SEQUENCE (SIZE |

(1..maxNrofBWPs)) OF BWP-Downlink

| | |
|---|---|
| firstActiveDownlinkBWP-Id | BWP-Id |
| bwp-InactivityTimer | ENUMERATED {ms2, ms3, ms4, |

ms5, ms6, ms8, ms10, ms20, ms30, ... }

| | |
|---|---|
| defaultDownlinkBWP-Id | BWP-Id |
| uplinkConfig | UplinkConfig |
| supplementaryUplink | UplinkConfig |
| pdcch-ServingCellConfig | SetupRelease { PDCCH-ServingCellConfig } |
| pdsch-ServingCellConfig | SetupRelease { PDSCH-ServingCellConfig } |
| csi-MeasConfig | SetupRelease { CSI-MeasConfig } |
| sCellDeactivationTimer | ENUMERATED {ms20, ms40, ... } |
| crossCarrierSchedulingConfig | CrossCarrierSchedulingConfig |
| tag-Id | TAG-Id, |

...,

bwp-InactivityTimer field indicates the duration in ms after which the UE falls back to the default Bandwidth Part. When the network releases the timer configuration, the UE stops the timer without switching to the default BWP.

defaultDownlinkBWP-Id field indicates the initial bandwidth part is referred to by BWP-Id=0. ID of the downlink bandwidth part to be used upon expiry of the BWP inactivity timer. This field is UE specific. When the field is absent the UE uses the initial BWP as default BWP.

downlinkBWP-ToAddModList field indicates list of additional downlink bandwidth parts to be added or modified.

downlinkBWP-ToReleaseList field indicates list of additional downlink bandwidth parts to be released.

firstActiveDownlinkBWP-Id field indicates, if configured for an SpCell, the ID of the DL BWP to be activated or to be used for RLM, BFD and measurements upon performing the RRC (re-)configuration.

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. The IE CSI-MeasConfig is also used to configure virtual CSI-RS (reference signals) belonging to the serving cell in which CSI-MeasConfig is included.

| | |
|---|---|
| CSI-MeasConfig ::= | SEQUENCE { |
| nzp-CSI-RS-ResourceToAddModList | SEQUENCE (SIZE |

(1..maxNrofNZP-CSI-RS-Resources)) OF NZP-CSI-RS-Resource

| | |
|---|---|
| nzp-CSI-RS-ResourceToReleaseList | SEQUENCE (SIZE (1..maxNrofNZP- |

CSI-RS-Resources)) OF NZP-CSI-RS-ResourceId

| | |
|---|---|
| nzp-CSI-RS-ResourceSetToAddModList | SEQUENCE (SIZE |

(1..maxNrofNZP-CSI-RS-ResourceSets)) OF NZP-CSI-RS-ResourceSet

| | |
|---|---|
| nzp-CSI-RS-ResourceSetToReleaseList | SEQUENCE (SIZE (1..maxNrofNZP- |

CSI-RS-ResourceSets)) OF NZP-CSI-RS-ResourceSetId

| | |
|---|---|
| csi-IM-ResourceToAddModList | SEQUENCE (SIZE (1..maxNrofCSI-IM- |

Resources)) OF CSI-IM-Resource

| | |
|---|---|
| csi-IM-ResourceToReleaseList | SEQUENCE (SIZE (1..maxNrofCSI- |

IM-Resources)) OF CSI-IM-ResourceId

| | |
|---|---|
| csi-IM-ResourceSetToAddModList | SEQUENCE (SIZE (1..maxNrofCSI- |

IM-ResourceSets)) OF CSI-IM-ResourceSet

| | |
|---|---|
| csi-IM-ResourceSetToReleaseList | SEQUENCE (SIZE (1..maxNrofCSI- |

IM-ResourceSets)) OF CSI-IM-ResourceSetId

| | |
|---|---|
| csi-SSB-ResourceSetToAddModList | SEQUENCE (SIZE (1..maxNrofCSI- |

SSB-ResourceSets)) OF CSI-SSB-ResourceSet

| | |
|---|---|
| csi-SSB-ResourceSetToReleaseList | SEQUENCE (SIZE (1..maxNrofCSI- |

SSB-ResourceSets)) OF CSI-SSB-ResourceSetId

| | |
|---|---|
| csi-ResourceConfigToAddModList | SEQUENCE (SIZE (1..maxNrofCSI- |

ResourceConfigurations)) OF CSI-ResourceConfig

| | |
|---|---|
| csi-ResourceConfigToReleaseList | SEQUENCE (SIZE (1..maxNrofCSI- |

ResourceConfigurations)) OF CSI-ResourceConfigId

| | |
|---|---|
| csi-ReportConfigToAddModList | SEQUENCE (SIZE (1..maxNrofCSI- |
| ReportConfigurations)) OF CSI-ReportConfig | OPTIONAL, -- Need N |
| csi-ReportConfigToReleaseList | SEQUENCE (SIZE (1..maxNrofCSI- |

ReportConfigurations)) OF CSI-ReportConfigId

| | |
|---|---|
| reportTriggerSize | INTEGER (0..6) |
| aperiodicTriggerStateList | SetupRelease { CSI-AperiodicTriggerStateList } |
| semiPersistentOnPUSCH-TriggerStateList | SetupRelease { CSI- |

```
SemiPersistentOnPUSCH-TriggerStateList }
    ...,
  -- TAG-CSI-MEASCONFIG-STOP
  -- ASN1STOP
```

csi-IM-ResourceSetToAddModList field indicates pool of CSI-IM-ResourceSet which can be referred to from CSI-ResourceConfig or from MAC CEs.

csi-IM-ResourceToAddModList field indicates pool of CSI-IM-Resource which can be referred to from CSI-IM-ResourceSet.

csi-ReportConfigToAddModList field indicates configured CSI report settings.

csi-ResourceConfigToAddModList field indicates configured CSI resource settings.

csi-SSB-ResourceSetToAddModList field indicates pool of CSI-SSB-ResourceSet which can be referred to from CSI-ResourceConfig.

nzp-CSI-RS-ResourceSetToAddModList field indicates pool of NZP-CSI-RS-ResourceSet which can be referred to from CSI-ResourceConfig or from MAC CEs.

nzp-CSI-RS-ResourceToAddModList field indicates pool of NZP-CSI-RS-Resource which can be referred to from NZP-CSI-RS-ResourceSet.

reportTriggerSize field indicates size of CSI request field in DCI (bits). The field reportTriggerSize applies to DCI format 0_1 and the field reportTriggerSizeDCI-0-2 applies to DCI format 0_2.

GNB can configure UE with one or more candidate AIML functions using RRCReconfiguration procedure. To configure AI/ML for beam management for one or more serving cells, GNB includes in the RRCReconfiguration message relevant parameters.

To perform AIML based BM1 for a target serving cell, GNB indicates candidate AIML based BM1 parameters in:
# the CSI-MeasConfig of the target serving cell; and
# the CSI-MeasConfig of a special cell, wherein the special cell is a cell configured with PUCCH.

In the CSI-MeasConfig of the target serving cell, GNB includes one or more CSI-ResourceConfig IEs. The IE CSI-ResourceConfig defines a group of one or more NZP-CSI-RS-ResourceSet, CSI-IM-ResourceSet and/or CSI-SSB-ResourceSet. The IE CSI-ResourceConfig defines either CSI-RS resource for Set A (CSI-RS configuration for CSI inference) or CSI-RS resource for Set B (CSI-RS configuration for CSI measurement).

```
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResouceSetList | CHOICE { |
| nzp-CSI-RS-SSB | SEQUENCE { |
| nzp-CSI-RS-ResourceSetList | SEQUENCE (SIZE (1..maxNrofNZP- |

CSI-RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI- |
| SSB-ResourceSetsPerConfig)) OF CSI-SSB-ResourceSetId | OPTIONAL -- Need R |

},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, |

```
periodic },
    ...,
    [[
```

| | |
|---|---|
| csi-SSB-ResourceSetListExt-r17 | CSI-SSB-ResourceSetId |

```
OPTIONAL -- Need R
    ]]
  [[
```

| resourceTypeExt | ENUMERATED | |
|---|---|---|
| { | forInferrence/virtual | } |

OPTIONAL -- Need R,

| | |
|---|---|
| associatedId | AssociatedId OPTIONAL -- Need R |

```
    ]]
  }
  -- TAG-CSI-RESOURCECONFIG-STOP
  -- ASN1STOP
```

bwp-Id field indicates the DL BWP which the CSI-RS associated with this CSI-ResourceConfig are located in.

csi-IM-ResourceSetList field indicates list of references to CSI-IM resources used for CSI measurement and reporting in a CSI-RS resource set.

csi-SSB-ResourceSetList field indicates list of references to SSB resources used for CSI measurement and reporting and CSI inference in a CSI-RS resource set.

nzp-CSI-RS-ResourceSetList field indicates list of references to NZP CSI-RS resources used for beam measurement and reporting and CSI inference in a CSI-RS resource set.

resourceType field indicates time domain behavior of resource configuration. It does not apply to resources provided in the csi-SSB-ResourceSetList.

resource TypeExt field indicates whether the resource configuration is for measurement or for inference. UE does not measure the CSI resource if resourceTypeExt field is present.

associatedId field indicates the A-ID associated with the resource configuration.

In the CSI-ResourceConfig for CSI-RS resource for Set A, resourceTypeExt and associatedId are comprised.

In the CSI-ResourceConfig for CSI-RS resource for Set B:
# resource TypeExt is not comprised; and
# associatedId is comprised.

In the CSI-ResourceConfig for normal CSI-RS resource, neither resourceTypeExt nor associatedId are comprised.

If resourceTypeExt is comprised in the CSI-ResourceConfig, UE ignores resourceType field, and UE determines the type of resource based on resourceTypeExt. If resourceTypeExt is not comprised in the CSI-ResourceConfig, UE determines the type of resource based on resourceType.

In the CSI-MeasConfig of the special cell (where PUCCH for CSI report is transmitted), GNB includes one or more CSI-ReportConfig IEs. The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI).

The IE CSI-ReportConfig defines:
# measurement_based_CSI_report in case that CSI-ReportConfig does not comprise:
## resourcesForChannelInference;
## associatedId; and
## reportBothResource;
# inference_based_CSI_report in case that CSI-ReportConfig:
## comprises resourceForChannelInference and associatedId; and
## does not comprise reportBothResource;
# Hybrid_CSI_report on PUCCH in case that CSI-ReportConfig comprises:
## resourceForChannelInference;
## associatedId; and
## reportBothResource.

```
  -- ASN1START
  -- TAG-CSI-REPORTCONFIG-START
```

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, /// |

pointer to CSI-ResourceConfig for CSI-RS resoruce for Set B ///

| | |
|---|---|
| resourcesForChannelInference | CSI-ResourceConfigId, |

OPTIONAL, /// pointer to CSI-ResourceConfig for CSI-RS resoruce for Set A ///

| | |
|---|---|
| associatedId | AssociatedId OPTIONAL -- Need R /// |

this field indicates associated ID of the AIML model/functionality associated with the CSI-
ReportConfig IE. UE uses this field to determine the AIML model associated with the CSI-
ReportConfig. it is used to indicate the AIML model/functionality in RRC message///

| | |
|---|---|
| shortAID | ShortAID OPTIONAL -- Need R /// |

this field indicates short associated ID of the AIML model/functionality associated with the
CSI-ReportConfig IE. It is used to indicate the AIML model/functionality in MAC CE or in
DCI///

| | |
|---|---|
| reportBothResource | ENUMERATED {enabled} OPTIONAL |

///if presnet, CSI report contains reportQuantity for resourceForChannelMeasurement and
reportQuantity for resourceForChannelinference///

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
(1..maxNrofUL-Allocations)) OF INTEGER(0..32)
        }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, |
| n4} | OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| timeRestrictionForChannelMeasurements | ENUMERATED |

{configured, notConfigured},

| | |
|---|---|
| groupBasedBeamReporting | CHOICE { |
| enabled | NULL, |
| disabled | SEQUENCE { |
| nrofReportedRS | ENUMERATED {n1, |
| n2, n3, n4} | OPTIONAL -- Need S |

```
        }
    },
```

| | |
|---|---|
| cqi-Table | ENUMERATED {table1, table2, table3, table4- |
| r17} | OPTIONAL, -- Need R |
| subbandSize | ENUMERATED {value1, value2}, |
| non-PMI-PortIndication | SEQUENCE (SIZE (1..maxNrofNZP-CSI-RS- |

ResourcesPerConfig)) OF PortIndexFor8Ranks OPTIONAL, -- Need R
...,

| | |
|---|---|
| reportQuantity-r16 | CHOICE { |
| cri-SINR-r16 | NULL, |
| ssb-Index-SINR-r16 | NULL |

}
OPTIONAL, -- Need R

| | |
|---|---|
| codebookConfig-r16 | CodebookConfig-r16 |

OPTIONAL -- Need R
]],

| | |
|---|---|
| reportQuantity-r17 | CHOICE { |
| cri-RSRP-Index-r17 | NULL, |
| ssb-Index-RSRP-Index-r17 | NULL, |
| cri-SINR-Index-r17 | NULL, |
| ssb-Index-SINR-Index-r17 | NULL |

```
    }
OPTIONAL -- Need R
  }
```

carrier field indicates in which serving cell the CSI-ResourceConfig indicated below are to be found. If the field is absent, the resources are on the same serving cell as this report configuration.

codebookConfig field indicates codebook configuration for Type-1 or Type-2 including codebook subset restriction.

cqi-FormatIndicator field indicates whether the UE shall report a single (wideband) or multiple (subband) CQI.

cqi-Table field indicates which CQI table to use for CQI calculation.

csi-IM-ResourcesForInterference field indicates CSI IM resources for interference measurement (in case that the CSI-ReportConfig is for measurement_based_CSI_report) or for interference inference (in case that the CSI-ReportConfig is for inference_based_CSI_report). csi-ResourceConfigId of a CSI-ResourceConfig included in the configuration of the serving cell indicated with the field “carrier” above. The CSI-ResourceConfig indicated here contains only CSI-IM resources. The bwp-Id in that CSI-ResourceConfig is the same value as the bwp-Id in the CSI-ResourceConfig indicated by resourcesForChannelMeasurement.

csi-ReportingBand field indicates a contiguous or non-contiguous subset of subbands in the bandwidth part which CSI shall be reported for (in case that the CSI-ReportConfig is for measurement_based_CSI_report) or which CSI shall be inferred for (in case that the CSI-ReportConfig is for inference_based_CSI_report). Each bit in the bit-string represents one subband in order of frequency position in the BWP. The right-most bit in the bit string represents the lowest subband with the lowest frequency position in the BWP. The choice determines the number of subbands (subbands3 for 3 subbands, subbands4 for 4 subbands, and so on).

csi-ReportMode field configures the CSI report modes Model or Mode 2.

csi-ReportSubConfigToAddModList field indicates list of CSI-ReportSubConfiguration(s) in a CSI report configuration to add or modify.

csi-ReportSubConfigToReleaseList field indicates list of CSI-ReportSubConfiguration(s) in a CSI report configuration to release.

groupBasedBeamReporting field turn on/off group beam based reporting.

nrofReportedGroups field indicates number of reported resource groups per CSI-report. Value n1 means one resource group, n2 means 2 resource groups, and so on. If nrofReportedGroups is configured, the UE ignores groupBasedBeamReporting (without suffix).

nrofReportedRS field indicates:
# the number (N) of measured RS resources to be reported per report setting in a non-group-based report (in case that the CSI-ReportConfig is for measurement_based_CSI_report); or
# the number (N) of inferred RS resources to be reported per report setting in a non-group-based report (in case that the CSI-ReportConfig is for inference_based_CSI_report).

numberOfSingleTRP-CSI-Model field configures the number of reported X CSIs when csi-ReportMode is set to ‘Mode 1’. The field is present only if csi-ReportMode configures Mode 1.

nzp-CSI-RS-ResourcesForInterference field indicates NZP CSI RS resources for interference measurement (in that the CSI-ReportConfig is case for measurement_based_CSI_report) or for interference inference (in case that the CSI-ReportConfig is for inference_based_CSI_report). csi-ResourceConfigId of a CSI-ResourceConfig included in the configuration of the serving cell indicated with the field “carrier” above. The CSI-ResourceConfig indicated here contains only NZP-CSI-RS resources. The bwp-Id in that CSI-ResourceConfig is the same value as the bwp-Id in the CSI-ResourceConfig indicated by resourcesForChannelMeasurement.

p0alpha field indicates index of the p0-alpha set determining the power control for this CSI report transmission.

pdsch-BundleSizeForCSI field indicates PRB bundling size to assume for CQI calculation when reportQuantity is CRI/RI/i1/CQI. If the field is absent, the UE assumes that no PRB bundling is applied.

pmi-FormatIndicator field indicates whether the UE shall report a single (wideband) or multiple (subband) PMI.

pucch-CSI-ResourceList field indicates which PUCCH resource to use for reporting on PUCCH.

reportConfigType field indicates time domain behavior of reporting configuration.

reportFreqConfiguration field indicates reporting configuration in the frequency domain.

reportQuantity field indicates the CSI related quantities to report.

reportingMode field configures the UE with reporting mode for group based reporting.

reportSlotConfig field indicates periodicity and slot offset.

reportSlotOffsetList, reportSlotOffsetListDCI-0-1 and reportSlotOffsetListDCI-0-2 indicate timing offset Y for semi persistent reporting using PUSCH. This field lists the allowed offset values. This list must have the same number of entries as the pusch-TimeDomainAllocationList in PUSCH-Config. A particular value is indicated in DCI. The network indicates in the DCI field of the UL grant, which of the configured report slot offsets the UE shall apply. The DCI value 0 corresponds to the first report slot offset in this list, the DCI value 1 corresponds to the second report slot offset in this list, and so on. The first report is transmitted in slot n+Y, second report in n+Y+P, where P is the configured periodicity.

resourcesForChannelMeasurement field indicates resources for channel measurement. csi-ResourceConfigId of a CSI-ResourceConfig included in the configuration of the serving cell indicated with the field “carrier” above. The CSI-ResourceConfig indicated here contains only NZP-CSI-RS resources and/or SSB resources. This CSI-ReportConfig is associated with the DL BWP indicated by bwp-Id in that CSI-ResourceConfig.

resourcesForChannelInference field indicates resource for channel inference. csi-ResourceConfigId of a CSI-ResourceConfig included in the configuration of the serving cell indicated with the field “carrier” above. The CSI-ResourceConfig indicated here contains only NZP-CSI-RS resources and/or SSB resources. This CSI-ReportConfig is associated with the DL BWP indicated by bwp-Id in that CSI-ResourceConfig.

subbandSize field indicates one out of two possible BWP-dependent values for the subband size. If csi-ReportingBand is absent, the UE shall ignore this field.

timeRestrictionForChannelMeasurements field indicates time domain measurement restriction for the channel (signal) measurements.

timeRestrictionForInterferenceMeasurements field indicates time domain measurement restriction for interference measurements.

As an example, measurement_based_CSI_report is performed as follows.
# CSI-MeasConfig for Cell A comprises a CSI-ResourceConfig (CSI-ResourceConfigId=n):
## resourceType indicates periodic;
# CSI-MeasConfig for Cell B comprises a CSI-ReportConfig (CSI-RepoertConfigId=m):
## carrier field indicates Cell A;
## resourcesForChannelMeasurement field indicates n;
## reportConfigType field comprises PUCCH-CSI-Resource IE for the current active uplink BWP;
# UE transmits CSI report on the PUCCH-CSI-Resource of the current active uplink BWP of Cell B;
# The CSI report comprises channel state information determined based on measurement on the CSI resources indicated by n.

As an example, inference_based_CSI_report is performed as follows. # CSI-MeasConfig for Cell A comprises:
## a first CSI-ResourceConfig (CSI-ResourceConfigId=n and resourceTypeExt field is present); and
## a second CSI-ResourceConfig (CSI-ResourceConfigId=p and resourceTypeExt field is absent);
# CSI-MeasConfig for Cell B comprises a CSI-ReportConfig (CSI-RepoertConfigId=m):
## carrier field indicates Cell A;
## resourcesForChannelMeasurement field indicates p;
## resourcesForChannelInference field indicates n;
## reportConfigType field comprises PUCCH-CSI-Resource IE for the current active uplink BWP;
# UE transmits CSI report on the PUCCH-CSI-Resource of the current active uplink BWP of Cell B if inference_based_CSI_report is activated by a specific MAC CE or by a specific DCI;
# The CSI report comprises channel state information for CSI resource indicated by n, wherein the channel state information for CSI resource is determined/inferred from measurement on the CSI resources indicated by p. UE does not measure CSI resource indicated by n.

As an example, hybrid_CSI_report is performed as follows.
# CSI-MeasConfig for Cell A comprises:
## a first CSI-ResourceConfig (CSI-ResourceConfigId=n and resourceTypeExt field is present); and
## a second CSI-ResourceCoinfig (CSI-ResourceConfigId=p and resourceTypeExt field is absent); # CSI-MeasConfig for Cell B comprises a CSI-ReportConfig (CSI-RepoertConfigId=m):
## carrier field indicates Cell A;
## resourcesForChannelMeasurement field indicates p;
## resourcesForChannelInference field indicates n;
## reportConfigType field comprises PUCCH-CSI-Resource IE for the current active uplink BWP;
## reportBoth field is present;
# UE transmits CSI report on the PUCCH-CSI-Resource of the current active uplink BWP of Cell B if inference_based_CSI_report is activated by a specific MAC CE or by a specific DCI;
# The CSI report comprises:
## channel state information for CSI resource indicated by n, wherein the channel state information for CSI resource is determined/inferred from measurement on the CSI resources indicated by p;
## channel state information for CSI resource indicated by p;
# UE does not measure CSI resource indicated by n.

For each serving cell, UE determines measurement_based_CSI_reports to be activated from one or more measurement_based_CSI-ReportConfig IEs. measurement_based_CSI-ReportConfig configures measurement_based_CSI_reporting.

UE considers a measurement_based_CSI_report of a specific measurement_based_CSI-ReportConfig IE is to be activated. The specific measurement_based_CSI-ReportConfig IE is measurement_based_CSI-ReportConfig IE of which reportConfigType field comprises a field for ‘periodic’. measurement_based_CSI-ReportConfig IE of which reportConfigType field comprises a field for ‘aperiodic’ or a field for ‘semi-persistent’ are considered to be deactivated. They are activated based on a specific MAC CE or a specific DCI.

For each serving cell, UE determines applicable inference_based_CSI_reports from one or more inference_based_CSI-ReportConfig IEs (applicable TIPs for BM1).

UE considers an inference_based_CSI_report is applicable in case that:
# the corresponding CSI-ReportConfig IE comprises the associatedId field that matches with that of AIML model for the concerned functionality that is available in the UE;
# the CSI-ResourceConfig of resourceForChannelInference and the CSI-ResourceConfig of resourceForChannelMeasurement are aligned with training profile of the AIML model for the concerned functionality.

GNB may configure UE to update the applicable TIPs by including relevant parameters in otherConfig IE in the RRCReconfiguration message.

UE consider itself to be configured to provide updated applicable TIPs in case that received otherConfig includes applicableCSIreportConfig.

| | |
|---|---|
| OtherConfig-v1900 ::= | SEQUENCE { |

```
    applicableCSIreportConfig SetupRelease { ApplicableCSIreportConfig }
OPTIONAL, -- Need M
    }
  ...
  ApplicableCSIreportConfig::= SEQUENCE {
```

| | |
|---|---|
| applicableCSIreportProhibitTimer | ENUMERATED {s0, s0dot5, s1, s2, s5, |

s10, s20, s30,

s60, s90, s120, s300, s600, spare3,

spare2, spare1}
}

/// Indicates the prohibit timer for reporting updated applicable CSI report configuration (or applicable TIPs). Value in seconds. Value s0 means prohibit timer is set to 0 seconds, value s0dot5 means prohibit timer is set to 0.5 seconds, value s1 means prohibit timer is set to 1 second and so on.///

If the RRCReconfiguration message comprises applicableCSIreportConfig, UE reports the applicable TIPs in the corresponding RRCReconfigurationComplete message and the updated applicable TIPs in UEAssistanceInformation.

At 3A41, UE performs applicable TIP reporting based on RRCReconfigurationComplete message or UEAssistanceInformation message.

If RRCReconfiguration comprises applicableCSIreportConfig (or UE is configured to report applicable TIP), UE performs an initial reporting and subsequent reportings and duplicate reporting.

The initial reporting is performed via RRCReconfigurationComplete message that are transmitted in response to the RRCReconfiguration message that comprises applicableCSIreportConfig.

The subsequent reporting is performed via UEAssistanceInformation message.

The duplicate reporting is performed via retransmission of UEAssistanceInformation message after successful completion of synchronous reconfiguration (e.g. reconfiguration with sync). UE performs retransmission of UEAssistanceInformation message upon successful completion of synchronous reconfiguration in case that:
# the UE initiated transmission of UEAssistanceInformation message during the last 1 second

The prohibit timer is utilized to prevent frequent reporting. Since the initial reporting is time-critical (GNB needs to know the applicable TIPs as soon as possible), the prohibit timer starts after transmission of RRCReconfigurationComplete message is initiated. In case of subsequent reporting, the prohibit timer starts before transmission of UEAssistanceInformation message is initiated.

| | |
|---|---|
| RRCReconfigurationComplete-v1900-IEs ::= | SEQUENCE { |
| applicableCSIreportList | ApplicableCSIreportList |

```
OPTIONAL,
  }
  ApplicableCSIreportList::= SEQUENCE (SIZE (1.. max)) OF ApplicableCSIReport
```

| | |
|---|---|
| ApplicableCSIReport ::= | SEQUENCE { |
| servCellIndex | ServCellIndex, |
| aimlModelId | AimlModelId, |
| associatedId | AssociatedId |
| shortAssociatedId | ShortAssociatedId |

}

With regards to applicable TIPS, UE performs first set of actions in case that:
# the RRCReconfiguration message comprises applicableCSIreportConfig; and
# At least one applicable inference_based_CSI_report configuration is available.

UE performs the first set of actions in the order. The first set of action comprises:
# setting the ApplicableCSIreportList based on the applicable inference_based_CSI_report configurations;
# initiating relevant procedures for transmission of RRCReconfigurationComplete message (e.g. putting the RRCReconfigurationComplete message in the transmission buffer of MAC entity and initiating SR procedure); and
# starting a prohibit timer with the timer value set to applicableCSIreportProhibitTimer.

UE performs second set of actions in case that:
# the RRCReconfiguration message comprises applicableCSIreportConfig (e.g. UE is configured to report applicable TIPs);
# At least one applicable inference_based_CSI_report configuration changes comparing to latest/last reported ones; and
# The prohibit timer is not running.

UE performs the second set of actions in the order. The first set of action comprises:
# starting the prohibit timer with the timer value set to applicableCSIreportProhibitTimer.
# setting the ApplicableCSIreportList based on the current applicable inference_based_CSI_report configurations;
# initiating relevant procedures for transmission of UEAssistanceInformation message (e.g. putting the message in the transmission buffer of MAC entity).

| | |
|---|---|
| UEAssistanceInformation-v1900-IEs ::= | SEQUENCE { |
| applicableCSIreportList | ApplicableCSIreportList |

```
OPTIONAL,
  }
  ApplicableCSIreportList::= SEQUENCE (SIZE (1.. max)) OF ApplicableCSIReport
```

| | |
|---|---|
| ApplicableCSIReport ::= | SEQUENCE { |
| servCellIndex | ServCellIndex, |
| aimlModelId | AimlModelId, |
| associatedId | AssociatedId |
| shortAssociatedId | ShortAssociatedId |

}

RRC-TransactionIdentifier in the RRCReconfiguration message and RRC-TransactionIdentifier in the RRCReconfigurationComplete message are same.

UEAssistanceInformation message does not comprise RRC-TransactionIdentifier.

Based on the information, GNB may determine to activate one or more AIML models to enable inference_based_CSI_reporting.

At 3A50, GNB activates one or more AIML models for BM1. An AIML model is identified by a CSI report configuration. Activation of the AIML model can be achieved by activating the corresponding CSI report configuration. In addition, GNB may need to inform UE which A-ID is applied with the CSI report configuration.

Activation of measurmenet_based_CSI_reporting is performed in a single step. GNB transmits a signal to inform the UE to activate the corresponding CSI reporting for measurement_based_CSI_reporting.

TABLE 1

| | CSI reporting configuration | | |
|---|---|---|---|
| | Periodic | Semi-Persistent | Aperiodic |
| CSI-RS | measurement_based_CSI | measurement_based_CSI | measurement_based_CSI |
| Configuration | Reporting | Reporting | Reporting |
| Periodic CSI- | No dynamic | For reporting on PUCCH, SP | The UE receives triggering |
| RS | triggering/activation (i.e. | CSI reporting on PUCCH | on DCI in DCI format 0_1 |
| | CSI reporting is activated | Activation/Deactivation MAC | or in DCI format 0_2. The |
| | upon configuration) | CE is received; | DCI comprises ‘CSI |
| | | for reporting on PUSCH, the | request’ field. The DCI is |
| | | UE receives triggering on DCI | addressed by C-RNTI. |
| | | in DCI format 0_1 or in DCI | UE performs AP CSI |
| | | format 0_2. The DCI is | reporting on PUSCH in the |
| | | addressed by SP CSI-RNTI. | serving cell where the DCI |
| | | UE activates/performs SP CSI | is received (or PUSCH |
| | | reporting on PUCCH in the | transmission is performed). |
| | | serving cell indicated by the | |
| | | MAC CE. | |
| | | UE activates/performs SP CSI | |
| | | reporting on PUCCH in the | |
| | | serving cell where the DCI is | |
| | | received (or PUSCH | |
| | | transmission is performed). | |
| Semi- | Not Supported | Same as above | Same as above |
| Persistent | | | |
| CSI-RS | | | |
| Aperiodic CSI- | Not Supported | Not Supported | Same as above |
| RS | | | |

### <Two Step Activation: AIML Inference>

Activation of AIML model for BM1 (activation of inference_based_CSI_reporting) is performed in two steps. GNB first informs UE A-ID of the CSI report configuration to be activated for BM1. GNB then transmits the signal to inform the UE to activate the corresponding CSI reporting for inference_based_CSI_reporting.

The first step may be skipped if only one A-ID is available/configured for the CSI report. To perform the first step, GNB may transmit a specific MAC CE (denoted as A-ID MAC CE). The A-ID MAC CE comprises one or more sets of fields. Each set of fields comprises Serving Cell index, CSI-ReportConfigId and A-ID. The UE determines the A-ID to be applied based on the associated CSI-ReportConfigId and Serving Cell Index.

The second step is performed as below.

TABLE 2

| | CSI reporting configuration | | |
|---|---|---|---|
| | Periodic | Semi-Persistent | Aperiodic |
| CSI-RS | inference_based_CSI | inference_based_CSI | inference_based_CSI |
| Configuration | Reporting for BM1 | Reporting for BM1 | Reporting for BM1 |
| Periodic CSI- | When A-ID is informed | For reporting on PUCCH, SP CSI | The UE receives |
| RS | for the CSI reporting | reporting on PUCCH | triggering on DCI in DCI |
| | (P-CSI reporting is | Activation/Deactivation MAC CE | format 0_1 or in DCI |
| | configured when CSI- | is received; | format 0_2. The DCI |
| | ReportConfig is | for reporting on PUSCH, the UE | comprises ‘CSI request’ |
| | received, and activated | receives triggering on DCI in DCI | field. The DCI is |
| | when corresponding A- | format 0_1 or in DCI format 0_2. | addressed by C-RNTI. |
| | ID MAC CE is received) | The DCI is addressed by SP CSI- | UE performs AP CSI |
| | | RNTI. | reporting on PUSCH in |
| | | UE activates/performs SP CSI | the serving cell where the |
| | | reporting on PUCCH in the | DCI is received (or |
| | | serving cell indicated by the MAC | PUSCH transmission is |
| | | CE. | performed). |
| | | UE activates/performs SP CSI | |
| | | reporting on PUCCH in the | |
| | | serving cell where the DCI is | |
| | | received (or PUSCH transmission | |
| | | is performed). | |
| Semi- | Not Supported | Same as above | Same as above |
| Persistent | | | |
| CSI-RS | | | |
| Aperiodic | Not Supported | Not Supported | Same as above |
| CSI-RS | | | |

### <One Step Activation>

Alternatively, a single MAC CE/DCI indicates both A-ID and CSI-ReportConfigId.

Instead of full A-ID, a short A-ID can be indicated in the DCI. The mapping between 5 the full A-ID and the short A-ID can be explicitly indicated in the RRCReconfiguration message. Alternatively, the mapping can be done based on a predefined rule (e.g. the last n bit of full A-ID is corresponding short A-ID; the part that are assigned by the base station is short A-ID etc).

One step activation of inference_based_CSI reporting is performed as below.

TABLE 3

| | CSI reporting configuration | | |
|---|---|---|---|
| | Periodic | Semi-Persistent | Aperiodic |
| CSI-RS | inference_based_CSI | inference_based_CSI | inference_based_CSI |
| Configuration | Reporting for BM1 | Reporting for BM1 | Reporting for BM1 |
| Periodic CSI- | Not supported | For reporting on PUCCH, SP AI | The UE receives triggering |
| RS | | CSI reporting on PUCCH | on DCI in DCI format 0_1 |
| | | Activation/Deactivation MAC | or in DCI format 0_2. The |
| | | CE is received; | DCI comprises ‘CSI |
| | | for reporting on PUSCH, the UE | request’ field. |
| | | receives triggering on DCI in | The DIC comprsies short A- |
| | | DCI format 0_1 or in DCI format | ID field. |
| | | 0_2. The DCI is addressed by | The DCI is addressed by C- |
| | | SP CSI-RNTI. The DCI | RNTI. |
| | | comprises short A-ID field. | UE performs AP CSI |
| | | UE activates/performs SP CSI | reporting on PUSCH in the |
| | | reporting on PUCCH in the | serving cell where the DCI |
| | | serving cell indicated by the | is received (or PUSCH |
| | | MAC CE. | transmission is performed). |
| | | UE activates/performs SP CSI | |
| | | reporting on PUCCH in the | |
| | | serving cell where the DCI is | |
| | | received(or PUSCH | |
| | | transmission is performed). | |
| Semi- | Not Supported | Same as above. | Same as above |
| Persistent CSI- | | | |
| RS | | | |
| Aperiodic CSI- | Not Supported | Not Supported | Same as above |
| RS | | | |

A-ID MAC CE is denoted as first MAC CE.

SP AI CSI reporting on PUCCH Activation/Deactivation MAC CE is denoted as second MAC CE.

SP CSI reporting on PUCCH Activation/Deactivation MAC CE is denoted as third MAC CE.

### <A-ID MAC CE>

The A-ID MAC CE (denoted as first MAC CE) (3D10) is identified by a MAC subheader with LCID. It has a variable size with following fields:
# Serving Cell ID: This field indicates the identity of the Serving Cell for which the following fields (short AID/BWP ID) applies. The length of the field is 5 bits;
# BWP ID: This field indicates a UL BWP for which the following field (short AID) applies as the codepoint of the DCI bandwidth part indicator field. The length of the BWP ID field is 2 bits;
# E: This field indicates whether another set of fields (Serving Cell ID, BWP ID, Short A-ID, E) follows after Short A-ID field;
# Short Associated ID: This field indicates the short A-ID of the SP AI CSI report configuration (e.g. activated inference_based_CSI_report configuration) to be activated for the BWP of the serving cell.

### <SP AI CSI Reporting on PUCCH Activation/Deactivation MAC CE>

The SP AI CSI reporting on PUCCH Activation/Deactivation MAC CE (denoted as second MAC CE) (3D20) is identified by a MAC subheader with LCID. It has a variable size with following fields:
# Serving Cell ID: This field indicates the identity of the Serving Cell for which the MAC CE applies. The length of the field is 5 bits;
# BWP ID: This field indicates a UL BWP for which the MAC CE applies as the codepoint of the DCI bandwidth part indicator field. The length of the BWP ID field is 2 bits;
# L: This field indicates whether the MAC CE applies to SP CSI reporting on PUCCH Activation/Deactivation for LTM or not. If ltm-CSI-ReportConfigToAddModList is not configured, R field is present instead (i.e. set to 0);
# Sᵢ: This field indicates the activation/deactivation status of the Semi-Persistent CSI report configuration within ltm-CSI-ReportConfigToAddModList if L field is set to 1, or csi-ReportConfigToAddModList if L field is set to 0. So refers to the report configuration which includes PUCCH resources for SP CSI reporting in the indicated BWP and has the lowest CSI-ReportConfigId or LTM-CSI-ReportConfigId within the list with type set to semiPersistentOnPUCCH, S₁ to the report configuration which includes PUCCH resources for SP CSI reporting in the indicated BWP and has the second lowest CSI-ReportConfigId or LTM-CSI-ReportConfigId and so on. If the number of report configurations within the list with type set to semiPersistentOnPUCCH in the indicated BWP is less than i+1, MAC entity shall ignore the Sᵢ field. The Sᵢ field is set to 1 to indicate that the corresponding Semi-Persistent CSI report configuration shall be activated. The Sᵢ field is set to 0 to indicate that the corresponding Semi-Persistent CSI report configuration i shall be deactivated. If the Semi-Persistent CSI report configuration i is configured with csi-ReportSubConfigToAddModList, the Sᵢ field is set to 0 to additionally indicate that all sub-configurations within csi-ReportSubConfigToAddModList shall be deactivated;
# R: Reserved bit, set to 0;
# Short Associated ID: This field indicates the short A-ID of the activated SP AI CSI report configuration (e.g. activated inference_based_CSI_report configuration).
## The field in the third octet corresponds to a CSI-ReportConfig that is associated with the lowest CSI-ReportConfigId or LTM-CSI-ReportConfigId among CSI-ReportConfigs that is:
## # within the list with type set to semiPersistentOnPUCCH; and
## # inference_based_CSI_report (e.g. configured with associatedId);
## The field in the fourth octet corresponds to a CSI-ReportConfig that is associated with the second lowest CSI-ReportConfigId or LTM-CSI-ReportConfigId among CSI-ReportConfigs that is:
## # within the list with type set to semiPersistentOnPUCCH; and
## # inference_based_CSI_report (e.g. configured with associatedId);

At 3A60, UE performs BM1 AIML model inference operation for a specific BWP of a specific serving cell. UE performs spatial-domain Downlink beam prediction for Set A of beams based on measurement results of Set B of beams. Set A is determined based on resourcesForChannelInference and Set B is determined based on resourcesForChannelMeasurement.

UE takes the measurement results of Set B as input to AIML model associated with the A-ID.

UE determines channel state information to be reported for Set B based on output of AIML model associated with the A-ID.

For semi-persistent inference_based_CSI reporting on PUCCH, UE determines:
# the specific serving cell based on the Serving Cell ID field in the third MAC CE (in case of two step activation) or in the second MAC CE (in case of one step activation);
# the specific BWP based on BWP ID field in the third MAC CE (in case of two step activation) or in the second MAC CE (in case of one step activation);
# the AIML model based on short A-ID field field in the first MAC CE (in case of two step activation) or in the second MAC CE (in case of one step activation);
# the AIML model and the Set A and the Set B are determined based on Si field in the third MAC CE (in case of two step activation) or in the second MAC CE (in case of one step activation);

For semi-persistent inference_based_CSI reporting on PUSCH or for aperiodic inference_based_CSI reporting on PUSCH, UE determines:
# the specific serving cell based on which serving cell the DCI is received (in case of self-scheduling) or on which serving cell PUSCH transmission is scheduled (in case of cross-carrier scheduling; scheduling serving cell is determined based on schedulingCellId field of CrossCarrierSchedulingConfig IE of scheduled cell; the specific serving cell is scheduled cell);
# the specific BWP based on BWP ID field in the DCI;
# the AIML model based on short A-ID field in the DCI (in case of one step activation) or in the first MAC CE (in case of two step activation);
# the AIML model and the Set A and the Set B are determined based on CSI request field in the DCI.

At 3A70, UE performs CSI reporting on PUCCH (or PUSCH). The CSI report comprises channel state information of Set A. The CSI report comprises channel state information of Set B in case that the CSI-ReportConfig comprises reportBoth field.

At 3A80, UE stops AIML model inference operation (UE deactivates AIML model) at a specific time point in case that:
# DCI that results in BWP switching is received, wherein the specific time point is determined based on active BWP switch delay;
# a specific timer expires that results in BWP switching, wherein the specific time point is determined based on active BWP switch delay;
# random access is triggered that results in BWP switching, wherein the specific time point is determined based on active BWP switch delay;
# RRCReconfiguration that triggers synchronous reconfiguration (reconfiguration with sync), wherein the specific time point is determined based on MAC reset (AIML model inference operation stops when MAC reset occurs);
# MAC reset occurs, wherein the specific time point is when MAC reset occurs.

At 3A90, UE resume/reactivate AIML model inference operation at a second specific time point in case that:
# active BWP switch occurs and AIML model is already activated in the new BWP (based on the first MAC CE or the second MAC CE), wherein the second specific time point is determined based on active BWP switch delay;
# reconfiguration with sync occurred and the MIB of the target SpCell is acquired (or SFN of the target SpCell is determined/acquired) wherein the second specific time point is when SFN of the target SpCell is determined/acquired.

At some point of time, GNB determines to handover the UE to another cell. GNB transmits UE a second RRCReconfiguration message that comprises Reconfiguration WithSync IE.

UE consider itself still configured to report applicable TIPs in the target cell in case that:
# applicableCSIreportConfig is not comprised in the second RRCReconfiguration message; and
# fullConfig is not configured (fullConfig is not comprised in the second RRCReconfiguration message).

UE consider itself still not configured to report applicable TIPs in the target cell in case that:
# applicableCSIreportConfig (that is set to release) is comprised in the second RRCReconfiguration message; or
# fullConfig is configured (fullConfig is comprised in the RRCReconfiguration message) and applicableCSIreportConfig is not comprised in the second RRCReconfiguration message.

UE performs handover procedure based on the CellGroupConfig and ReconfigurationWithSync. UE performs random access procedure in the target cell. UE receives MIB in the target cell. UE acquires SFN of the target cell based on the received MIB. UE transmits a second RRCReconfigurationComplete message in the target cell. When random access procedure is successfully completed, UE consider handover is successfully completed.

UE includes the applicableCSIreportList in the second RRCReconfigurationComplete message in case that:
# UE is still configured to report applicable TIPs in the target cell; and
# applicable TIPs reported in the source cell (before handover) is not same as currently applicable TIPs.

UE does not include the applicableCSIreportList in the second RRCReconfigurationComplete message otherwise.

UE starts the prohibit timer after transmission of the second RRCReconfigurationComplete message.

UE determines to transmit applicableCSIreportList in UEAssistanceInformation in case that:
# the prohibit timer is not running (or stopped and not restarted); and
# current applicableCSIreportList is not equal to the last reported one.

UE determines to transmit applicableCSIreportList in RRCReconfigurationComplete in case that:
# the prohibit timer is running or not running (stopped and not restarted); and
# current applicableCSIreportList is not equal to the last reported one.

RRC-TransactionIdentifier in the RRCReconfiguration message (that comprised applicableCSIreportConfig; that provided configuration for reporting of applicable TIPs) and RRC-TransactionIdentifier in the second RRCReconfigurationComplete message (that comprises information on applicable TIPs and that are transmitted after synchronous reconfiguration is initiated) are different.

RRC-TransactionIdentifier in the RRCReconfiguration message (that comprised applicableCSIreportConfig; that provided configuration for reporting of applicable TIPs) and RRC-TransactionIdentifier in the first RRCReconfigurationComplete message (that comprises information on applicable TIPs and that are transmitted before synchronous reconfiguration is initiated/completed) are same.

RRC-TransactionIdentifier in the first RRCReconfigurationComplete message and RRC-TransactionIdentifier in the second RRCReconfigurationComplete message are different.

For UE side model, data collection and training are performed inside the UE. Data training for UE side AIML model are performed in the following steps:
# Steps for reporting capability (3A10 and 3A20);
# Steps for configuring training resource request (3B21 and 3B22);
# Steps for configuring training resource (3B23, 3A31 and 3B40);
# Steps for training data (3B50); and
# Steps for completing training data (3B60).

For Network side model, data collection and training are performed in network entity. Data training for network side AIML model are performed in the following steps:
# Steps for reporting capability (3A10 and 3A20);
# Steps for configuring training resource, training data logging and training data collection (3B23 and 3A31 and 3B40);
# Steps for collecting training data (3B70); and
# Steps for reporting training data (3B80 and 3B90 and 3B100).

At 3A20, UE and GNB perform followings in addition.

UE includes AIML-Parameters-data-training in the UE-NR-Capability IE.

The IE AIML-Parameters-data-training is used to convey the subset of UE Radio Access Capability Parameters that apply to data training of AIML function/feature integrated to NR. The IE may comprise:
# list of AIML functions/features (and associated A-IDs if available) of which UE-side data training is supported by UE;
# list of AIML functions/features (and associated A-IDs if available) of which data collection is supported by UE;
Based on the AIML-Parameters-data-training, GNB decides to configure UE with data training/collection for some of AIML functions/features.

At 3B21, GNB and UE perform followings.

GNB transmits UE RRCReconfiguration. GNB includes in the RRCReconfiguration following IEs to configure UE to request training resource.

UE consider itself to allow to request training resource in case that received otherConfig includes training-resource-request-config.

| | |
|---|---|
| OtherConfig-v1900 ::= | SEQUENCE { |
| request-training-resource-config | SetupRelease {Request-training-resource- |

```
config} OPTIONAL, -- Need M
    }
  ...
  Request-Training-resource-config::= SEQUENCE {
```

| | |
|---|---|
| training-resource-request-ProhibitTimer | ENUMERATED {s0, s0dot5, s1, s2, |

s5, s10, s20, s30,

s60, s90, s120, s300, s600, spare3,

spare2, spare1}

--Indicates the prohibit timer for requesting training resource. Value in seconds. Value s0 means prohibit timer is set to 0 seconds, value s0dot5 means prohibit timer is set to 0.5 seconds, value s1 means prohibit timer is set to 1 second and so on.--

At 3B22, UE transmits GNB RRCReconfigurationComplete message.

The RRCReconfigurationComplete message may comprise applicableCSIreportList in case that:
# the RRCReconfiguration message comprises applicableCSIreportConfig; and
# At least one applicable inference_based_CSI_report configuration is available.

The RRCReconfigurationComplete message does not comprise request-training-resource (UE does not request training resource) even in case that:
# the RRCReconfiguration message comprises request-training-resource-config; and
# At least one request-training-resource is available (e.g. UE is ready to request training resource for UE side model training).

Or alternatively, to facilitate fast configuration, UE may include the request-training-resource in the RRCReconfigurationComplete message in case that:
# the RRCReconfiguration message comprises request-training-resource-config; and
# At least one request-training-resource is available (e.g. UE is ready to request training resource for UE side model training).

At 3B23, UE transmits to GNB UEAssistanceInformation to request training resource.

| | |
|---|---|
| UEAssistanceInformation ::= | SEQUENCE { |
| criticalExtensions | CHOICE { |
| ueAssistanceInformation | UEAssistanceInformation-IEs, |
| criticalExtensionsFuture | SEQUENCE { } |

```
    }
  }
```

| | |
|---|---|
| UEAssistanceInformation-v1900-IEs ::= | SEQUENCE { |
| applicableCSIreportList | ApplicableCSIreportList |

OPTIONAL,

| | |
|---|---|
| requst-training-resource | Request-training-resource |

OPTIONAL,
}

| | |
|---|---|
| Request-training-resource ::= | SEQUENCE { |

-- frequency doemain resource info --

| | |
|---|---|
| servCellIndex | ServCellIndex, |
| bwpId | BWP-Id, |

-- time domain resource info --

| | |
|---|---|
| periodicity | Periodicity, |
| duration | Duration |

```
  -- beam related info -
  input-beamInfo (e.g. # of input beams; if asbsent, SSB of the serving cell is assumed)
      output-beamInfo (e.g. # of output beams, or # of Set A beams)
  -- AIML info -
  aimlModelIdentification AIMLModelId (e.g. indicates BM1 or BM2)
```

| | |
|---|---|
| associatedId | AssociatedId (if this field is absent, GNB allocates |

AID for this training resources and inform it to the UE in training resource configuration. If
this field is present, GNB configures the resource and associated transmission parameters
according to the A-ID)
}

Request-training-resource IE comprises a set of parameters that characterize the training resource requested. servingCellIndex field indicates the serving cell for which training resource is requested to be configured. bwpId field indicates the downlink BWP of the serving cell for which training resource is requested to be configured. periodicity field indicates the requested periodicity of training resource. duration field indicates the requested duration of training resource (e.g. overall duration while the training resource is requested to be transmitted or # of symbols of each CSI-RS resource). Input-beamInfo field comprises information on number of input beams and other parameters related to input beams (e.g. Tx power, codebook, number of ports, CDM type etc). Output-beamInfo field comprises information on number of output beams and other parameters related to output beams.

Based on Request-training-resource IE, GNB determines to configure UE with training resource (and other resource if needed).

At 3A31, GNB provides UE resource configuration for training resource. GNB and UE perform followings in addition.

GNB includes training resource configuration in two or more CSI-ResourceConfig IE in CSI-MeasConfig for a specific serving cell. At least one CSI-ResourceConfig IE is for source training resource and at least one CSI-ResourceConfig IE is for target training resource. Source training resource is the resource where Set B beams are transmitted. Target training resource is the resource where Set B beams are transmitted.

CSI-ResourceConfig for training resource configuration comprises resourceUsage field in addition to table x

| | |
|---|---|
| resourceUsage | ENUMERATED { sourceTraining, |

targetTraining } OPTIONAL -- Need R,

The field indicates whether the CSI resource is source training resource or target training resource.

Alternatively, whether the CSI resource is source training resource or target training resource is determined implicitly. If the CSI-ResourceConfig IE comprises associatedId field and csi-SSB-ResourceSetList (e.g. CSI resource consists with SSB resource), UE determines the CSI resource is source training resource. If the CSI-ResourceConfig IE comprises associatedId field and nzp-CSI-RS-ResourceSetList (e.g. CSI resource consists with NZP CSI resource), UE determines the CSI resource is target training resource.

To start training related operations, target training resource should be activated. If the resourceType of the target training resource is ‘periodic’, target training resource is activated when configured. UE can start training related operation immediately (e.g. upon configuration or reconfiguration). UE proceeds directly to 3B50. If the resourceType of the target training resource is ‘semiPersistent’, target training resource is not activated when configured. UE proceeds to 3B40.

In case of network side model, GNB may include training data logging configuration in RRCReconfiguration.

At 3B40, GNB activates the training resource. GNB transmits to the UE either:
# SP CSI-RS/CSI-IM Resource Set Activation/Deactivation MAC CE; or
# SP CSI-RS Resource Configuration Activation/Deactivation MAC CE.

The network may activate and deactivate the configured Semi-persistent CSI-RS/CSI-IM resource sets of a Serving Cell by sending the SP CSI-RS/CSI-IM Resource Set Activation/Deactivation MAC CE (3C30). The configured Semi-persistent CSI-RS/CSI-IM resource sets are initially deactivated upon (re-)configuration by upper layers and after reconfiguration with sync.

UE considers training resource is activated in case that:
# all CSI-RS resource sets associated with the CSI-ResourceConfig for source training resource configuration; and
# all CSI-RS resource sets associated with the CSI-ResourceConfig for target training resource configuration.

UE starts training when the last CSI-RS resource set (or all the resource sets) of CSI-RS resource sets associated either with the CSI-ResourceConfig for source training resource or with the CSI-ResourceConfig for target training resource is activated.

One MAC PDU may contain more than one SP CSI-RS/CSI-IM Resource Set Activation/Deactivation MAC CEs.

UE starts training when a MAC PDU containing a specific MAC CE is received. The specific MAC CE is the SP CSI-RS/CSI-IM Resource Set Activation/Deactivation MAC CE that activates the last CSI-RS resource set of CSI-RS resource sets associated either with the CSI-ResourceConfig for source training resource or with the CIS-ResourceConfig for target training resource.

The SP CSI-RS/CSI-IM Resource Set Activation/Deactivation MAC CE (3D30) is identified by a MAC subheader with LCID. It has a variable size and consists of the following fields:
# A/D: This field indicates whether to activate or deactivate indicated SP CSI-RS and CSI-IM resource set(s). The field is set to 1 to indicate activation, otherwise it indicates deactivation;
# Serving Cell ID: This field indicates the identity of the Serving Cell for which the MAC CE applies. The length of the field is 5 bits;
# BWP ID: This field indicates a DL BWP for which the MAC CE applies as the codepoint of the DCI bandwidth part indicator field. The length of the BWP ID field is 2 bits;
# SP CSI-RS resource set ID: This field contains an index of NZP-CSI-RS-ResourceSet containing Semi Persistent NZP CSI-RS resources indicating the Semi Persistent NZP CSI-RS resource set, which shall be activated or deactivated. The length of the field is 6 bits;
# IM: This field indicates the presence of the octet containing SP CSI-IM resource set ID field. If the IM field is set to 1, the octet containing SP CSI-IM resource set ID field is present. If IM field is set to 0, the octet containing SP CSI-IM resource set ID field is not present;
# SP CSI-IM resource set ID: This field contains an index of CSI-IM-ResourceSet containing Semi Persistent CSI-IM resources indicating the Semi Persistent CSI-IM resource set, which shall be activated or deactivated. The length of the field is 6 bits;
# TCI State IDᵢ: This field contains TCI-StateId of a TCI State, which is used as QCL source for the resource within the Semi Persistent NZP CSI-RS resource set indicated by SP CSI-RS resource set ID field. TCI State ID₀ indicates TCI State for the first resource within the set, TCI State ID₁ for the second one and so on. The length of the field is 7 bits. If the A/D field is set to 0, the octets containing TCI State ID field(s) are not present;

The network may activate and deactivate the configured Semi-persistent CSI-RS resource configurations of a Serving Cell by sending the SP CSI-RS resource configuration Activation/Deactivation MAC CE (3D40). The configured Semi-persistent CSI-RS resource configurations are initially deactivated upon (re-)configuration by upper layers and after reconfiguration with sync.

UE considers training resource is activated and starts training in case that the SP CSI-RS Resource Configuration Activation/Deactivation MAC CE in case that both CSI-ResourceConfig for source training resource and CSI-ResourceConfig for target training resource are activated. In case that the all resource sets in CSI-ResourceConfig for source training resource are already being transmitted (e.g. resourceType is periodic), UE starts training when the SP CSI-RS Resource Configuration Activation/Deactivation MAC CE that activates the CSI resource configuration for the target training resource.

The SP CSI-RS Resource Configuration Activation/Deactivation MAC CE is identified by a MAC subheader with LCID. It has a variable size and consists of the following fields:
# A/D: This field indicates whether to activate or deactivate indicated SP CSI-RS resource configuration. The field is set to 1 to indicate activation, otherwise it indicates deactivation;
# Serving Cell ID: This field indicates the identity of the Serving Cell for which activation/deactivation is applied. The length of the field is 5 bits;
# BWP ID: This field indicates a DL BWP for which the MAC CE applies as the codepoint of the DCI bandwidth part indicator field. The length of the BWP ID field is 2 bits;
# CSI-RS resource configuration ID: This field contains CSI-ResourceConfigId, indicating the CSI-RS resource configuration, which shall be activated or deactivated. The length of the field is 7 bits;
# E: This field indicates whether another set of A/D, Serving Cell ID, BWP ID, CSI-RS resource configuration ID and E follows.

At 3B50, UE starts training for a AIML model (associated with a A-ID) when training resource for the AIML model is activated.

For AIML model training, UE measures Set B beams (downlink signal transmitted on source training resource) and Set A beams (downlink signal transmitted on target training resource). UE puts the measurement results of Set B beams into the AIML model. Then UE compares the output of the AIML model (Set A beams inferred based on the Set B beams) and measured Set A beams. Based on the comparison, UE updates the parameters of the AIML model accordingly.

When the UE determines that training is completed, UE proceeds to 3B60 to inform GNB that training resource is not needed anymore.

If BWP switching occurs during on-going training, UE stops on-going training and proceeds to 3B60 to inform GNB that training is not completed yet. UE resumes the training when UE switches back to the BWP where training resource is configured and activated.

If training resource is deactivated during on-going training, UE stops on-going training and proceeds to 3B60 to inform GNB that training is not completed yet. UE resumes the training when the training resource is reactivated.

At 3B60, UE transmits to GNB UEAssistanceInformation message to inform GNB necessity of training resource.

| | |
|---|---|
| UEAssistanceInformation-v1900-IEs ::= | SEQUENCE { |
| applicableCSIreportList | ApplicableCSIreportList |

OPTIONAL,

| | |
|---|---|
| requst-training-resource | Request-training-resource |

OPTIONAL,

| | |
|---|---|
| training-status | ENUMERATED {completed, ongoing} |
| associatedId | AssociatedId |

If UE has completed training while training resource is still activated, UE determines to generate and transmit UEAssistanceInformation message. The message comprises:
# training-status field set to completed; and
# associatedId field set to AssociatedId of the AIML model for which training is completed. Network can determine the CSI resource configuration for source training resource and the CSI resource configuration for target training resource based on the A-ID indicated in this field.

Network may deactivate the training resource configuration for source training resource and the training resource configuration for target training resource. If the source training resource is cell specific reference signal (e.g. SSB), network deactivates only the training resource configuration for target training resource.

If UE has not completed training but training resource is not activated yet (or deactivated; or BWP switching occurs), UE determines to generate and transmit UEAssistanceInformation message. The message comprises:
# training-status field set to ongoing; and
# associatedId field set to AssociatedId of the AIML model for which training is ongoing.

For data collection in network side model, following steps are performed.
# Steps for reporting capability (3A10 and 3A20);
# Steps for configuring data logging (3A31)
# Steps for data logging (3B70)
# Steps for reporting training data (3B80 and 3B90 and 3B100).

At 3A20, UE and GNB perform followings in addition.

UE includes AIML-Parameters-data-training in the UE-NR-Capability IE.

The IE AIML-Parameters-data-training is used to convey the subset of UE Radio Access Capability Parameters that apply to data training of AIML function/feature integrated to NR. The IE may comprise:
# list of AIML functions/features (and associated A-IDs if available) of which UE-side data training is supported by UE;
# list of AIML functions/features (and associated A-IDs if available) of which data collection is supported by UE;
# list of AIML functions/features (and associated A-IDs if available) of which data logging is supported by UE;
# memory size for data logging

If UE supports data logging for at least one AIML function/feature, UE supports SRB6.

Based on the AIML-Parameters-data-training, GNB decides to configure UE with data training/collection for some of AIML functions/features.

At 3A31, GNB may include training data logging configuration in CSI-MeasConfig.

Main points of training-data-logging is as follows.
# To minimize amount of logging, evaluation-based periodic logging is supported.
# If evaluation result meets specific condition during specific period (determined based on evaluationConfig; or if a specific event occurs or if specific set of conditions are satisfied), UE logs measurement results on specific resource periodically/regularly until another condition is met. measurement results taken at a time is a measurement-sample. UE logs one or more measurement-samples each time when the evaluation result meets specific/predefined condition. number of measurement-samples per evaluation result (or triggered event) is determined based on loggingConfig.
# UE generates a sub-report for each event that causes training-data-logging. In each sub-report, UE includes parameters such as absolute time when the event is fulfilled and the cause that trigger the logging.
## Each sub-report contains one or more measurement-samples. Each measurement-sample contains:
## # measurement results of n best first beams;
## # information to identify the n best first beams;
## # measurement results of m best second beams; and
## # information to identify one or more second beams.
# first beams are source training beams.
# second beams are target training beams.
# information to identify first beams (and second beams) are:
## a first identity (CSI-ResourceGroupId; collectively indicates the first resource set and the second resource set and the serving cell and BWP); and
## a second information (indicating one of first resource set and second resource set); and
## a third identity (NZP-CSI-RS-ResourceSetId or CSI-SSB-ResourceSetId)
# n best first beams and m best second beams are sorted by RSRP.

training-data-logging configuration and relevant parameters are proved in a AIML-MeasLoggingConfig in CSI-MeasConfig.

| | |
|---|---|
| AIML-MeasLoggingConfig ::= | SEQUENCE { |
| LoggingResourceConfig | SEQUENCE (SIZE (1..xxx)) OF AIML-Resource- |

Group-for-logging

| | |
|---|---|
| LoggingConfig | SEQUENCE (SIZE (1..xxx)) OF AIML- |

logging-Config

| | |
|---|---|
| otherAimlParameters | AimlParameters -- AIML model |

information and associated ID --

| | |
|---|---|
| FilterCoefficient ::= | ENUMERATED { fc0, fc1, fc2, fc3, fc4, fc5, fc6, fc7, |

```
fc8, fc9, fc11, fc13, fc15, fc17, fc19, spare1, ...}
  -- The IE FilterCoefficient specifies the measurement filtering coefficient. Value fc0
corresponds to k = 0, fc1 corresponds to k = 1, and so on.--
  }
  -- Information on CSI resource of which measurement result is logged--
```

| | |
|---|---|
| AIML-Resource-Group-for-logging::= | SEQUENCE { |
| AIML-Resource-GroupId | AIML- |

ResourceGroupId,
-- representing two resource set to be logged --

| | |
|---|---|
| AIML-Resource-for-logging | NZP-CSI-RS- |

ResourceSetId or CSI-SSB-ResourceSetId
-- CSI resource for source training -

| | |
|---|---|
| AIML-Resource-for-logging2 | NZP-CSI-RS- |

ResourceSetId or CSI-SSB-ResourceSetId
-- CSI resource for target training -

| | |
|---|---|
| servingCell | ServCellIndex |

OPTIONAL,
-- indicates the serving cell where the resource is configured. if this field is absent, the
servingell associated with CSI-MeasConfig or assocaited with parent ServingCellConfig is
assumed --

| | |
|---|---|
| bwpId | BWP-Id -- indicates the |

```
downlinkn BWP where the resource is configured --
  }
  -- Information on CSI logging --
```

| | |
|---|---|
| AIML-logging-Config::= | SEQUENCE { |
| evaluationConfig | EvaluationConfig, |
| loggingConfig | LoggingConfig |

}

| | |
|---|---|
| EvaluationConfig::= | SEQUENCE { |
| evaluationConfigId | EvaluationConfigId |
| evalutationType | ENUMERATED |

```
{aboveThres, belowThres, bestBeam,... },
  -- if evaluationType is aboveThres, logging starts if L3 filtered SS-RSRP of the serving
cell is above threshold 1 for timeToTrigger --
  -- if evaluationType is belowThres, logging starts if L3 filtered SS-RSRP of the serving
cell is below threshold 2 for timeToTrigger -
  -- the serving cell is the cell where CSI-MeasConfig is received --
  -- if evaluationType is bestBeam, logging starts if best beam after L3 filtering among
a specific set of beams changes. The specific set of beams is idnetified by AIML-Resource-
GroupId(2) of the AIML-Resource-Group-for-logging --
```

| | |
|---|---|
| threshold1 | MeasTriggerQuantity |
| threshold2 | MeasTriggerQuantity |
| resourceForEvaluation | AIML-ResourceGroupId, |

-- indicates AIML-Resource-Group that are used for evaluation. This field is present
if evaluationType is bestBeam. this field is absent in case that evaluationType is aboveThres
or belowThres. --

| | |
|---|---|
| subResourceForEvaluation | ENUMERATED {first, second}, |

```
  -- if set to first, the specific set of beams is determined by csi-Resoruce-for-logging of
the assocaited evaluation resource. if set to second, the sepcific set of beams is determined byu
AIML-Resource-for-logging2. This field is present if evaluationType is bestBeam --
  timeToTrigger
```

| | |
|---|---|
| LoggingConfig::= | SEQUENCE { |
| resoureForLogging | AIML-ResourceGroupId |

```
  -- indicates AIML-Resource-Group for logging. UE loggs regularly, when resource
conditon (resource is activated)and evaluation condition (configurd by evaluationConfig) are
fulfilled, n best beams of source training beams and m best beams of target training beams --
  nrofbeamsOfFirstResourceSetPerMeasSubReport
  -- indicates number of best beams among beams of csi-Resoruce-for-logging (first
resource set) whose L1 filtered measurement result is to be logged--
  nrofbeamsOfSecondResourceSetPerMeasSubReport
  -- indicates number of best beams among beams of csi-Resoruce-for-logging2 (second
resource set) whose L1 filtered measurement result is to be logged--
  loggingPeriodicity
  -- indicates the periodicity of logging during a loggin-sub-campagin. It corresponds to
T3xz --
  loggingDurationSample
  -- indicates the length of duration of a logging-sub-campagin. It corresponds to T3xy
--
  loggingDurationOverall
  -- indicates the lenght of duration of a logging-campagin. It corresponds to T3xz--
  nrofSamples
  -- indicates total/maximum number of samples for this logging-campagin.--
  }
```

| | |
|---|---|
| MeasTriggerQuantity ::= | CHOICE { |
| rsrp | RSRP-Range, |
| rsrq | RSRQ-Range, |
| sinr | SINR-Range |

}

In case that training data logging is configured, UE proceeds to 3B70 when both source training resource and target training resource are activated (as in 3B40).

UE starts T3xx (configured by loggingDurationOverall). UE performs evaluation for logging based on evaluationConfig. UE determines/checks if a specific condition (configured by evaluationType) is fulfilled for specific resource (configured by resourceForEvaluation) for a specific time duration (configured by timeToTrigger). If so, UE starts T3xy. UE performs logging at regular interval (configured by loggingPeriodcitiy and controlled by T3xz) during a specific duration (configured by loggingDurationForSamplieGroup) or while T3xy is running.

UE performs a logging-campaign 3C10 for a AIML-MeasLoggingConfig. The logging-campaign starts in case that:
# AIML-MeasLoggingConfig is received 3C20; and
# both source training resource and target training resource are activated/available (e.g., at least one pair of resource sets associated with a CSI resource group is activated by MAC CE or by RRC message) 3C30.

UE starts T3xx when logging-campaign starts 3C40.

The logging-campaign ends in case that:
# T3xx expires 3C50;
# specific UE internal issue (e.g. memory allocated to logging is exhausted or remaining battery level is below a threshold) occurs; or
# Specific event such as RLF, Beam failure, synchronous reconfiguration (intra-NR handover based on Reconfiguration WithSync) or mobilityFromNR occurs.

When the logging-campaign stops/ends, UE release logging-campaign configuration (e.g. AIML-MeasLoggingConfig).

During a logging-campaign, UE performs one or more logging sub-campaign 3C60 3C70.

Logging sub-campaign starts in case that:
# AIML-MeasLoggingConfig is received 3C20; and
# both source training resource and target training resource are activated/available (e.g., at least one pair of resource sets associated with a CSI resource group is activated by MAC CE or by RRC message) 3C30; and
# conditions indicated/configured/defined by evalutationType is fulfilled 3C80.

UE starts T3xy when logging sub-campaign starts 3C90.

The logging-sub-campaign ends in case that:
# T3xy expires 3C100; or
# logging campaign ends.

During a logging sub-campaign, UE takes a sample per interval (controlled by T3xz).

For each sample, followings are logged
# L1-RSRPs (and resource ids) of n source beams;
# L1-RSRPs (and resource ids) of m target beams;
# L3-RSRP of serving cell (L3 filtered cell quality based on beam consolidation/selection)
# L3 filtered cell quality and L3 calculated measurement result and representative RSRP of cell and cell-level measurement result are used interchangeably.

UE stops logging-campaign in case that:
# number of logging-samples reaches a specific number (derived from periodicity and duration); or
# training resource becomes unavailable (due to BWP switch or CSI-RS resource deactivation); or
# RRC connection state transition; or
# Reconfiguration WithSync (synchronous reconfiguration occurs); or
# Memory for logging is full; or
# UE power is below a threshold.

Since the first four causes are known to the base station, UE silently stops logging-campaign if logging-campaign stops due to one of the four causes. UE triggers UAI transmission in case that logging-campaign stops due to one of last two causes.

If T3xx expires while T3xy is running, UE does not end logging-campaign until T3xy expires (e.g. when T3xx expires UE continues logging until T3xy expires; logging-campaign stops when neither T3xx nor T3xy are running)

At 3B80, UE transmits to the GNB UEAssistanceInformation.

| | |
|---|---|
| UEAssistanceInformation-v1900-IEs ::= | SEQUENCE { |
| applicableCSIreportList | ApplicableCSIreportList |

OPTIONAL,

| | |
|---|---|
| requst-training-resource | Request-training-resource |

OPTIONAL,

| | |
|---|---|
| training-status | ENUMERATED { completed,ongoing } |
| associatedId | AssociatedId |
| loggedDataReportAvailable | ENUMERATED {true} |
| logging-stop | ENUMERATED { yes } |
| logging-stop-cause | ENUMERATED { internalCause, resource } |

UE consider itself to be configured to provide logged data report indication
(loggedDataReportAvailable, logging-stop, logging-stop-cause) in case that received
otherConfig (at 3B21) includes loggedDataReportIndication.

| | |
|---|---|
| OtherConfig-v1900 ::= | SEQUENCE { |
| request-training-resource-config | SetupRelease { Request-training-resource- |
| config } | OPTIONAL, -- Need M |
| loggedDataReportIndication | SetupRelease |
| { LoggedDataReportIndication } | OPTIONAL, -- Need M |

```
    }
  ...
  LoggedDataReportIndication::= SEQUENCE {
```

| | |
|---|---|
| LoggedDataReportIndication-ProhibitTimer | ENUMERATED {s0, s0dot5, |

s1, s2, s5, s10, s20, s30,

s60, s90, s120, s300, s600, spare3,

spare2, spare1}

--Indicates the prohibit timer for indicating logged data report availability. Value in seconds. Value s0 means prohibit timer is set to 0 seconds, value s0dot5 means prohibit timer is set to 0.5 seconds, value s1 means prohibit timer is set to 1 second and so on.--

If UE has completed a logging-campaign (or the logging-campaign stops or T3xx expires), UE determines to generate and transmit UEAssistanceInformation message. The message comprises:
# loggedDataReportAvailable field indicates that logged data is available for reporting;
# logging-stop field is present and set to a proper value in case that logging stops due to either memory issue or battery issue or resource issue (e.g. training resource is not available due to BWP switch or resource deactivation);
# logging-stop-cause field is present and set to a proper value in case that logging-stop field is present.

```
  GNB may transmits UEInformationRequest mesasge to the UE to request logged-data
  UEInformationRequest-v199-IEs ::= SEQUENCE {
```

| | |
|---|---|
| logDataReportReq-r19 | ENUMERATED {true} |

```
OPTIONAL, --Need N
    }
  GNB includes logDataReportReq field in the message.
  UE transmits to the GNB UEInformatinoResponse message. The
UEInformationResponse message comprises a LogDataReport.
```

| | |
|---|---|
| UEInformationResponse-v1900-IEs ::= | SEQUENCE { |
| LogDataReport LogDataReport | OPTIONAL, |

```
  -- LogDataReport is generated per logging-campaign --
  ...
  }
  LogDataReport ::= SEQUENCE {
```

| | |
|---|---|
| commonInformation | CommonInformation OPTIONAL, |
| LogDataSubReportList | LogDataSubReportList, |
| LogDataAvailable-r16 | ENUMERATED {true} |

```
OPTIONAL,
  }
  CommonInformation::= SEQUENCE {
```

| | |
|---|---|
| absoluteTimeStamp | AbsoluteTimeInfo, |
| relativeTimeStampUnit | Enumerated {milisecond, slotSCS30, slotSCS60,...} |
| aimlParameters | AimlParameters |

}

| | |
|---|---|
| LogDataSubReportList::= | SEQUENCE (SIZE (1..xxx)) OF |

LogDataSubReport
LogDataSubReport ::= SEQUENCE {

| | |
|---|---|
| absoluteTimeStamp | AbsoluteTimeInfo, |
| evaluationConfigId | EvaluationConfigId |

evaluationType

| | |
|---|---|
| resourceForLogging | AIML-ResourceGroupId |
| logSampleList | LogSampleList |

```
  }
  LogSampleList::= SEQUENCE (SIZE (1..xxx)) OF LogSample
  LogSample ::= SEQUENCE {
```

| | |
|---|---|
| relativeTimeStamp | INTEGER (0..7200) |

```
        OPTIONAL,
  /// this field indicates the time point when the logSample is taken. It indicates the time
distance between the current time stamp and the previous time stamp ///
```

| | |
|---|---|
| loggedMeasResult | LoggedMeasResult |

}

| | |
|---|---|
| LoggedMeasResult | SEQUENCE { |
| cellResults | SEQUENCE{ |

```
  /// cell measurement results of the concerned serving cell ///
  /// concerned serving cell is the serving cell for which logging is perforomed///
  /// cell measurement result is derived based on layer 3 filtered measurement results of
DDB or CSI-RS ///
```

| | |
|---|---|
| resultsSSB-Cell | MeasQuantityResults |

OPTIONAL,

| | |
|---|---|
| results-CSI-RS-Cell | MeasQuantityResults |

OPTIONAL
},

| | |
|---|---|
| rsIndexResultsSetA | SEQUENCE{ |

```
  /// beam index and beam measurement results of n best beams of set A beams (e.g.
beams configured by AIML-Resource-for-logging) ///
  /// beam measurement result is derived based on layer 1 filtered and layer 3 unfiltered
measurement results of corresponding beam ///
```

| | |
|---|---|
| resultsSSB-Indexes | ResultsPerSSB-IndexList |

OPTIONAL,

| | |
|---|---|
| resultsCSI-RS-Indexes | ResultsPerCSI-RS-IndexList |

OPTIONAL
}
OPTIONAL

| | |
|---|---|
| rsIndexResultsSetB | SEQUENCE{ |

```
  /// beam index and beam measurement result of m best beams of set B beams (e.g.
beams configured by AIMBL-Resource-for-logging2) ///
  /// beam measurement result is derived based on layer 1 filtered and layer 3 unfiltered
measurement results of corresponding beam ///
```

| | |
|---|---|
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
      }
OPTIONAL
    },
```

| | |
|---|---|
| ResultsPerSSB-IndexList::= | SEQUENCE (SIZE |

(1..maxNrofIndexesToReport2)) OF ResultsPerSSB-Index

| | |
|---|---|
| ResultsPerSSB-Index ::= | SEQUENCE { |
| ssb-Index | SSB-Index, |
| ssb-Results | MeanQuantityResults |

```
OPTIONAL
  }
  /// ssb-Index is index of SSB of the concerned serving cell ///
  /// ssb-Results is layerindex of SSB of the concerned serving cell ///
  /// ssb-Results is layer-1 filtered/laer-3 unfiltered measurement result ///
```

| | |
|---|---|
| ResultsPerCSI-RS-IndexList::= | SEQUENCE (SIZE |

(1..maxNrofIndexesToReport2)) OF ResultsPerCSI-RS-Index

| | |
|---|---|
| ResultsPerCSI-RS-Index ::= | SEQUENCE { |

```
  bwpId
  BWP-Id
```

| | |
|---|---|
| nzp-csi-RS-Index | NZP-CSI-RS-ResourceId, |
| nzp-csi-RS-Results | RSRP-Range2 |

```
OPTIONAL
  }
  /// NZP-CSI-RS-ResourceId is id of NZP-CSI-RS-Resource configured in the
indicted BWP of the concerned serving cell///
  /// nzp-csi-RS-Results is layer-1 filtered/layer-3 unfiltered measurement result ///
```

| | |
|---|---|
| MeasQuantityResults ::= | SEQUENCE { |
| rsrp | RSRP-Range |

OPTIONAL,

| | |
|---|---|
| rsrq | RSRQ-Range |
| | OPTIONAL, |
| sinr | SINR-Range |

OPTIONAL
}

RSRP-Range::=INTEGER(0 . . . 127)

/// The IE RSRP-Range specifies the value range used in RSRP measurements and thresholds. For measurements, integer value for RSRP measurements is according to column 2 of Table 4. For thresholds, the actual value is (IE value−156) dBm, except for the IE value 127, in which case the actual value is infinity///

RSRQ-Range::=INTEGER(0 . . . 127)

/// The IE RSRQ-Range specifies the value range used in RSRQ measurements and thresholds. For measurements, integer value for RSRQ measurements is according to Table 4. For thresholds, the actual value is (IE value−87)/2 dB.///

RSRP-Range2::=INTEGER(0 . . . 127)

/// The IE RSRP-Range2 specifies the value range used in RSRP measurements and thresholds. For measurements, integer value for RSRP measurements is according to column 3 of 4 of table 4///

UE may perform following:
# starting a first set of operations [logging-campaign] in case that all of first set of conditions are satisfied;
# stopping the first set of operations in case that any of second set of conditions are satisfied;
# transmitting a UAI to indicate availability of logged data in case that all of a third set of conditions are satisfied; and
# transmitting one or more UEInformationResponse messages to report logged measurement results in case that all of a fourth set of conditions are satisfied.

wherein the first set of conditions are satisfied in case that:
# a set of parameters for logging [AIML-MeasLoggingConfig] is received;
# a second set of resource [target training resource] is available for measurement [activated]; and
# a third set of resource [source training resource] is available for measurement [activated].

wherein the second set of conditions are satisfied in case that:
# a specific duration [T3xx] elapsed since the first set of operations started;
# number of samples taken during the campaign (while T3xx is runnin) reaches a specific threshold [nrofSamples];
# radio link failure on PCell occurs while logging-campaign is performed on a SCell (or on the PCell);
# radio resource reestablishment procedure is initiated;
# radio resource reconfiguration procedure for synchronous reconfiguration is instructed;
# mobility to other radio access technology is instructed;
# RRC connection state transition to RRC_INACTIVE or RRC_IDLE occurs; or
# UE internal issue occurs.

wherein, for the first set of operations, the terminal:
# starts T3xx;
# evaluates whether a first condition [evaluationType] is fulfilled while T3xx is running;
# starts a second set of operations [sub-campaign] in case that:
## the first condition is fulfilled;
## the second set of operations is not ongoing; and
## T3xx is running.

wherein, for the second set of operations, the terminal:
# starts T3xy;
# takes layer 1 filtered measurement results regularly on the second set of resources and on the third set of resources during while T3xy is running.

The first condition related to:
# a calculated measured result of a first set of resources [SSB of serving cell; aboveThres or belowThres];
# a calculated measured result of the serving cell [SSB of serving cell; aboveThres or belowThres]; or
# calculated measured results of second/third set of resource [bestBeam],

wherein:
# the condition related to the calculated measured result of the first set of resource is satisfied in case that the calculated measured result of the first set of resource is above/below a first/second threshold;
# the first threshold is configured based on AIML-MeasLoggingConfig;
# the first threshold [threshold1 or threshold2] is configured based on a first range [−156˜−31; second column of table 10.1.6.1-2],

wherein:
# the condition related to the calculated measured result of the serving cell in case that the calculated measured result of the serving cell is above/below a first/second threshold;
# the first threshold is configured based on AIML-MeasLoggingConfig;
# the first threshold is configured based on a first range [−156˜−31; second column of table 10.1.6.1-2].

wherein:
# the condition related to the calculated measured results of second/third set of resource is satisfied in case that the best resource among the second/third set of resources in terms of calculated measured result changes; and
# the second/third set of resources are configured based on resourceForEvaluation.

the third set of conditions is fulfilled in case that:
# the terminal is configured to provide available information of logged measurement result;
# logging-campaign has been completed/stopped;
logged measurement result (transfer of any part/segment has not started yet) is available;
# prohibit timer is not running; and
# UE information procedure for logged measurement result transfer is not on-going (or logged measurement result transfer has been started and not completed yet).

UAI comprises a parameter/field indicating that:
# a logging-campaign is completed; and
# logged measurement results taken during the logging-campaign is available.

The fourth set of conditions is fulfilled in case that:
# UEInformationRequest is received;
# logDataReportReq is included in the UEInformationRequest; and
# UE has logDataReport available for reporting.

The UEInformationResponse comprises one or more LogDataSubReports.

The UEInformationResponses comprises LogDataAvailable field in case that at least one LogDataSubReport remains after transmission of the one or more LogDataSubReports.

Each of LogDataSubReports comprises:
# a first timestamp for reference time;
# a first identifier [evaluationConfigId] that collectively indicates the relevant event and the relevant resource;
# a second identifier [AIML-ResourceGroupId] that collectively indicates two or more sets of resources whose measurement results are logged; and
# one or more sets of measurement result containers [LogSample].

Each of measurement result containers comprises:
# a second timestamp [LogSample] that indicates the time point, based on the reference time stamp, when the measurement results in the container are taken;
# a cell-level measurement result [cellResults];
# first set of beam-level measurement results [cellResults]; and
# second set of beam-level measurement results [cellResults].

Unit of the first time stamp is a second and unit of the second time stamp is a milli-second (or what is configured by the based station),

wherein:
# both the cell-level measurement result and the beam-level measurement result are indicated in terms of RSRP;
# both the cell-level measurement result and the beam-level measurement result are indicated by a 7-bit index;
# the cell-level measurement result is set to the 7-bit index that is determined based on a first range [−156˜−31; second column of table 10.1.6.1-2] of a first look-up table;
# the beam-level measurement results is set to the 7-bit index that is determined based on a second range [−140˜−44; third column of table 10.1.6.1-2] of the first look-up table;
# the cell-level measurement result is determined based on a specific mathematical operation with layer-1 filtered beam level measurement results as input; and
# the beam-level measurement result is layer-1 filtered results.

TABLE 4

| | Measured quantity | Measured quantity | |
|---|---|---|---|
| Reported | value (L3 SS-RSRP) | value (L1 SS-RSRP | |
| value | and CSI-RSRP | and CSI-RSRP) | Unit |
| RSRP_0 | SS-RSRP < −156 | Not valid | dBm |
| RSRP_1 | −156 ≤ SS-RSRP < −155 | Not valid | dBm |
| RSRP_2 | −155 ≤ SS-RSRP < −154 | Not valid | dBm |
| RSRP_3 | −154 ≤ SS-RSRP < −153 | Not valid | dBm |
| RSRP_4 | −153 ≤ SS-RSRP < −152 | Not valid | dBm |
| RSRP_5 | −152 ≤ SS-RSRP < −151 | Not valid | dBm |
| RSRP_6 | −151 ≤ SS-RSRP < −150 | Not valid | dBm |
| RSRP_7 | −150 ≤ SS-RSRP < −149 | Not valid | dBm |
| RSRP_8 | −149 ≤ SS-RSRP < −148 | Not valid | dBm |
| RSRP_9 | −148 ≤ SS-RSRP < −147 | Not valid | dBm |
| RSRP_10 | −147 ≤ SS-RSRP < −146 | Not valid | dBm |
| RSRP_11 | −146 ≤ SS-RSRP < −145 | Not valid | dBm |
| RSRP_12 | −145 ≤ SS-RSRP < −144 | Not valid | dBm |
| RSRP_13 | −144 ≤ SS-RSRP < −143 | Not valid | dBm |
| RSRP_14 | −143 ≤ SS-RSRP < −142 | Not valid | dBm |
| RSRP_15 | −142 ≤ SS-RSRP < −141 | Not valid | dBm |
| RSRP_16 | −141 ≤ SS-RSRP < −140 | RSRP < −140 | dBm |
| RSRP_17 | −140 ≤ SS-RSRP < −139 | −140 ≤ RSRP < −139 | dBm |
| RSRP_18 | −139 ≤ SS-RSRP < −138 | −139 ≤ RSRP < −138 | dBm |
| . . . | . . . | | . . . |
| RSRP_111 | −46 ≤ SS-RSRP < −45 | −46 ≤ RSRP < −45 | dBm |
| RSRP_112 | −45 ≤ SS-RSRP < −44 | −45 ≤ RSRP < −44 | dBm |
| RSRP_113 | −44 ≤ SS-RSRP < −43 | −44 ≤ RSRP | dBm |
| RSRP_114 | −43 ≤ SS-RSRP < −42 | Not valid | dBm |
| RSRP_115 | −42 ≤ SS-RSRP < −41 | Not valid | dBm |
| RSRP_116 | −41 ≤ SS-RSRP < −40 | Not valid | dBm |
| RSRP_117 | −40 ≤ SS-RSRP < −39 | Not valid | dBm |
| RSRP_118 | −39 ≤ SS-RSRP < −38 | Not valid | dBm |
| RSRP_119 | −38 ≤ SS-RSRP < −37 | Not valid | dBm |
| RSRP_120 | −37 ≤ SS-RSRP < −36 | Not valid | dBm |
| RSRP_121 | −36 ≤ SS-RSRP < −35 | Not valid | dBm |
| RSRP_122 | −35 ≤ SS-RSRP < −34 | Not valid | dBm |
| RSRP_123 | −34 ≤ SS-RSRP < −33 | Not valid | dBm |
| RSRP_124 | −33 ≤ SS-RSRP < −32 | Not valid | dBm |
| RSRP_125 | −32 ≤ SS-RSRP < −31 | Not valid | dBm |
| RSRP_126 | −31 ≤ SS-RSRP | Not valid | dBm |
| RSRP_127 | Infinity | Infinity | dBm |
| (Note) | | | |

(Note):
The value of RSRP_127 is applicable for RSRP threshold configured by the network, but not for the purpose of measurement reporting.

wherein:
# the calculated measured result is obtained based on the specific mathematical operation over a specific time duration (timeToTrigger);
# the specific mathematical operation is weighted summation of measurement results;
# portion of latest measurement result, in the specific mathematical operation, is weighed more than portion of second latest measurement result;
# the specific time duration is configured by timeToTrigger in AIML-MeasLoggingConfig; and
# ratio between the portion of latest measurement result and the portion of second latest measurement result is configured by filteringCoefficient in AIML-MeasLoggingConfig

UE may perform following:
# starting a second set of operations [logging-sub-campaign] in case that all of fifth set of conditions are satisfied;
# stopping the second set of operations in case that any of sixth set of conditions are satisfied;
# transmitting a UAI to indicate availability of logged data in case that all of a third set of conditions are satisfied; and
# transmitting one or more UEInformationResponse messages to report logged measurement results in case that all of a fourth set of conditions are satisfied.

wherein the fifth set of conditions comprises:

a condition related to:
# a calculated measured result of a first set of resources [SSB of serving cell; aboveThres or belowThres]; or
# a calculated measured result of the serving cell [SSB of serving cell; aboveThres or belowThres]; or
# calculated measured results of second/third set of resource [bestBeam];
a condition related to status of a second set of resource [target training resource]; and/or
a condition related to status of a third set of resource [source training resource],

wherein:
the condition related to status of the second/third set of resource [source/target training resource] is fulfilled in case that the second/third set of resource is activated/being transmitted in the currently active downlink BWP or the second/third set of resource is activated via layer 2 medium access control message (or via layer 1 downlink control information) in the currently active downlink BWP.

wherein the sixth set of conditions are satisfied incase that:
# a specific duration [T3xy] elapsed since the first set of operations started;
# number of samples taken during the campaign (while T3xx is runnin) reaches a specific threshold [nrofSamples];
# radio link failure on PCell occurs while logging-campaign is performed on a SCell (or on the PCell);
# radio resource reestablishment procedure is initiated;
# radio resource reconfiguration procedure for synchronous reconfiguration is instructed;
# mobility to other radio access technology is instructed;
# RRC connection state transition to RRC_INACTIVE or RRC_IDLE occurs; or
# UE internal issue occurs.

### <CSI-RS>

CSI-RS (Channel State Information Reference Signal) is a component in 5G NR networks for channel estimation and measurement. The configuration of CSI-RS resources is flexible and can be tailored to specific network requirements.

### ## Time Domain Configuration

CSI-RS resources can be configured in various ways within the time domain:
## # Symbol Allocation: A CSI-RS resource may occupy 1, 2, or 4 OFDM symbols, depending on the configured number of ports.
## # Symbol Positions: CSI-RS can start at any OFDM symbol within a slot. For Tracking Reference Signal (TRS) purposes, specific symbol positions like {4,8}, {5,9}, and {6,10} are supported.
## # Periodicity: CSI-RS can be periodic, semi-persistent, or aperiodic (triggered by Downlink Control Information).

### ## Frequency Domain Configuration

The frequency domain allocation of CSI-RS is highly configurable:
## # Resource Blocks: CSI-RS can be allocated to a specific set of Resource Blocks (RBs) within the carrier bandwidth[1].
## # RB Offset: The starting RB for CSI-RS transmission can be specified (0 to 268, in steps of 4)[2].
## # Density: This parameter quantifies the number of Resource Elements (REs) allocated to CSI-RS per RB per port (0.5, 1, or 3).

### ## Port Configuration

CSI-RS supports various port configurations:
## # Number of Ports: A CSI-RS resource can correspond to 1 to 32 different antenna ports.
## # CDM Type: When multiple ports share the same RE allocation, Code Division Multiplexing (CDM) is used. Options include FD-CDM2, CDM4-FD2-TD2, etc.

### ## Power Control

CSI-RS power can be controlled relative to other signals:
## # Power Control Offset: Specifies the transmit power difference between CSI-RS and PDSCH (−8 to 15 dB)[1].
## # Power Control Offset SS: Defines the power difference between CSI-RS and SSS (−3, 0, 3, 6 dB)[1].

### ## CSI-RS Types

There are three main types of CSI-RS:
## # Non-Zero Power (NZP) CSI-RS: Used for channel measurement and estimation.
## # Zero Power (ZP) CSI-RS: Informs UEs about REs not mapped to data, increasing available REs.
## # CSI Interference Measurement (CSI-IM): Used for interference measurement.

### ## Configuration Considerations

When configuring CSI-RS resources, the base station consider the following:
## # Bandwidth Allocation: While it's possible to allocate CSI-RS to a subset of the total bandwidth, using all available PRBs provides more comprehensive channel information.
## # Purpose-Specific Configuration: Different CSI-RS configurations may be used for various purposes. For example, CSI-RS for PMI (Precoding Matrix Indicator) reports typically use a minimum of 4 ports, while single-port configurations may be used for other purposes.
## # UE Capability: The configuration should align with UE capabilities, which are reported to the network.

The IE NZP-CSI-RS-ResourceSet is a set of Non-Zero-Power (NZP) CSI-RS resources (their IDs) and set-specific parameters.

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S
...

### <TCI State>

The Transmission Configuration Indication (TCI) state plays a role in defining how data is transmitted and received between the User Equipment (UE) and the base station.

### ## Definition and Purpose

TCI states are a set of parameters that define the transmission configuration for downlink (DL) and uplink (UL) signals. These parameters are essential for the UE to correctly decode and process the received signals.

### ## TCI State Indication

TCI states are dynamically indicated to the UE through Downlink Control Information (DCI) messages. These messages include configurations such as Quasi Co-Location (QCL) information, which helps the UE to assume similar radio channel properties for different signals.

### ## QCL and TCI States

QCL is closely related to TCI states. QCL indicates that certain signals (e.g., PDSCH, CORESET, PDCCH) have similar radio channel properties, allowing the UE to use the same channel estimation for these signals. The TCI state for PDSCH, for example, can be the same as the TCI state for CORESET/PDCCH, simplifying the UE's processing.

### ## Activation and Deactivation

TCI states can be activated or deactivated through specific control elements in the DCI messages. For instance, up to two TCI states can be activated per TCI codepoint of the DCI, one for DL signals/channels and one for UL signals/channels, in the case of “Separate DL/UL TCI”.

### ## TCI State Information

The TCI state information is critical for various operations, such as direct Secondary Cell (SCell) activation. The network requires the TCI state information to ensure proper configuration and to avoid conflicts or misconfigurations.

### ## UE Reporting

The UE's knowledge of the TCI state is considered “known” if it has reported a Layer 1 Reference Signal Received Power (L1-RSRP) or Layer 3 RSRP measurement to the network within a specified time. This ensures that the UE and the network are synchronized regarding the transmission configuration.

### ## Configuration

### <Measurements>

In RRC_CONNECTED, the UE measures multiple beams (at least one) of a cell and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the gNB.

The corresponding high-level measurement model is described in FIG. 3E:
# A: measurements (beam specific samples) internal to the physical layer.
# Layer 1 filtering: internal layer 1 filtering of the inputs measured at point A. Exact filtering is implementation dependent. How the measurements are actually executed in the physical layer by an implementation (inputs A and Layer 1 filtering) is not constrained by the standard.
# A¹: measurements (i.e. beam specific measurements) reported by layer 1 to layer 3 after layer 1 filtering.
# Beam Consolidation/Selection: beam specific measurements are consolidated to derive cell quality. The behaviour of the Beam consolidation/selection is standardised and the configuration of this module is provided by RRC signalling. Reporting period at B equals one measurement period at A¹.
# B: a measurement (i.e. cell quality) derived from beam-specific measurements reported to layer 3 after beam consolidation/selection.
# Layer 3 filtering for cell quality: filtering performed on the measurements provided at point B. The behaviour of the Layer 3 filters is standardised and the configuration of the layer 3 filters is provided by RRC signalling. Filtering reporting period at C equals one measurement period at B.
# C: a measurement after processing in the layer 3 filter. The reporting rate is identical to the reporting rate at point B. This measurement is used as input for one or more evaluation of reporting criteria.
# Evaluation of reporting criteria: checks whether actual measurement reporting is necessary at point D. The evaluation can be based on more than one flow of measurements at reference point C e.g. to compare between different measurements. This is illustrated by input C and C¹. The UE shall evaluate the reporting criteria at least every time a new measurement result is reported at point C, C¹. The reporting criteria are standardised and the configuration is provided by RRC signalling (UE measurements).
# D: measurement report information (message) sent on the radio interface.
# L3 Beam filtering: filtering performed on the measurements (i.e. beam specific measurements) provided at point A¹. The behaviour of the beam filters is standardised and the configuration of the beam filters is provided by RRC signalling. Filtering reporting period at E equals one measurement period at A¹.
# E: a measurement (i.e. beam-specific measurement) after processing in the beam filter. The reporting rate is identical to the reporting rate at point A¹. This measurement is used as input for selecting the X measurements to be reported.
# Beam Selection for beam reporting: selects the X measurements from the measurements provided at point E. The behaviour of the beam selection is standardised and the configuration of this module is provided by RRC signalling.
# F: beam measurement information included in measurement report (sent) on the radio interface.

Layer 1 filtering introduces a certain level of measurement averaging. How and when the UE exactly performs the required measurements is implementation specific to the point that the output at B fulfils the performance requirements set in TS 38.133. Layer 3 filtering for cell quality and related parameters used are specified in TS 38.331. L3 Beam filtering and related parameters used are specified in TS 38.331.

SS reference signal received power (SS-RSRP) is defined as the linear average over the power contributions (in [W]) of the resource elements that carry secondary synchronization signals. The measurement time resource(s) for SS-RSRP are confined within SS/PBCH Block Measurement Time Configuration (SMTC) window duration. If SS-RSRP is used for L1-RSRP as configured by reporting configurations, the measurement time resources(s) restriction by SMTC window duration is not applicable.

For SS-RSRP determination demodulation reference signals for physical broadcast channel (PBCH) and, if indicated by higher layers, CSI reference signals in addition to secondary synchronization signals may be used. SS-RSRP using demodulation reference signal for PBCH or CSI reference signal shall be measured by linear averaging over the power contributions of the resource elements that carry corresponding reference signals taking into account power scaling for the reference signals as defined in TS 38.213. If SS-RSRP is not used for L1-RSRP, the additional use of CSI reference signals for SS-RSRP determination is not applicable. SS-RSRP shall be measured only among the reference signals corresponding to SS/PBCH blocks with the same SS/PBCH block index and the same physical-layer cell identity. If SS-RSRP is not used for L1-RSRP and higher-layers indicate certain SS/PBCH blocks for performing SS-RSRP measurements, then SS-RSRP is measured only from the indicated set of SS/PBCH block(s).

CSI reference signal received power (CSI-RSRP), is defined as the linear average over the power contributions (in [W]) of the resource elements of the antenna port(s) that carry CSI reference signals configured for RSRP measurements within the considered measurement frequency bandwidth in the configured CSI-RS occasions. For CSI-RSRP determination CSI reference signals transmitted on antenna port 3000 according to TS 38.211 shall be used. If CSI-RSRP is used for L1-RSRP, CSI reference signals transmitted on antenna ports 3000, 3001 can be used for CSI-RSRP determination. For intra-frequency CSI-RSRP measurements, if the measurement gap is not configured, UE is not expected to measure the CSI-RS resource(s) outside of the active downlink bandwidth part.

The measurement configuration includes the following parameters:
# Measurement objects: A list of objects on which the UE shall perform the measurements.
## For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
## The measObjectId of the MO which corresponds to each serving cell is indicated by servingCellMO within the serving cell configuration.
# Reporting configurations: A list of reporting configurations where there can be one or multiple reporting configurations per measurement object. Each measurement reporting configuration consists of the following:
## Reporting criterion: The criterion that triggers the UE to send a measurement report. This can either be periodical or a single event description.
## RS type: The RS that the UE uses for beam and cell measurement results (SS/PBCH block or CSI-RS).
## Reporting format: The quantities per cell and per beam that the UE includes in the measurement report (e.g. RSRP) and other associated information such as the maximum number of cells and the maximum number beams per cell to report.
# Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.
# Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

### <Layer 3 Filtering>

The UE shall:
# for each cell measurement quantity and for each beam measurement quantity:
## filter the measured result, before using for evaluation of reporting criteria, for measurement reporting, for U2N/U2U Relay (re) selection evaluation or for evaluating the SyncRef UE, by the following formula:

$$Fn = ( 1 - a ) * Fn - 1 + a * Mn$$

where
Mn is the latest received measurement result from the physical layer;
Fn is the updated filtered measurement result, that is used for evaluation of reporting criteria (e.g. logging condition evaluation);
Fn−1 is the old filtered measurement result, where F0 is set to M1 when the first measurement result from the physical layer is received; and for MeasObjectNR, a=½\hat{ }(ki/4), where ki is the filterCoefficient for the corresponding measurement quantity of the i:th QuantityConfigNR in quantityConfigNR-List, and i is indicated by quantityConfigIndex in MeasObjectNR; for other measurements, a=½\hat{ }(k/4), where k is the filterCoefficient for the corresponding measurement quantity received by the quantityConfig;
## adapt the filter such that the time characteristics of the filter are preserved at different input rates, observing that the filterCoefficient k assumes a sample rate equal to X ms; The value of X is equivalent to one intra-frequency L1 measurement period assuming non-DRX operation, and depends on frequency range.

### <Derivation of Cell Measurement Results>

Cell measurement result and cell-level measurement result are used interchangeably.

The network may configure the UE in RRC_CONNECTED to derive RSRP, RSRQ and SINR measurement results per cell associated to NR measurement objects based on parameters configured in the measObject (e.g. maximum number of beams to be averaged and beam consolidation thresholds) and in the reportConfig (rsType to be measured, SS/PBCH block or CSI-RS). For

The UE shall:
# for each cell measurement quantity to be derived based on SS/PBCH block:
## if nrofSS-BlocksToAverage is not configured in the associated measObject in RRC_CONNECTED; or
## if absThreshSS-BlocksConsolidation is not configured in the associated measObject in RRC_CONNECTED; or
## if the highest beam measurement quantity value is below or equal to absThreshSS-BlocksConsolidation:
## # derive each cell measurement quantity based on SS/PBCH block as the highest beam measurement quantity value, where each beam measurement quantity is described in TS 38.215;
## else:
## # derive each cell measurement quantity based on SS/PBCH block as the linear power scale average of the highest beam measurement quantity values above absThreshSS-BlocksConsolidation where the total number of averaged beams shall not exceed nrofSS-BlocksToAverage;
## if in RRC_CONNECTED, apply layer 3 cell filtering;
# for each cell measurement quantity to be derived based on CSI-RS:
## consider a CSI-RS resource to be applicable for deriving cell measurements when the concerned CSI-RS resource is included in the csi-rs-CellMobility including the physCellId of the cell in the CSI-RS-ResourceConfigMobility in the associated measObject;
## if nrofCSI-RS-ResourcesToAverage in the associated measObject is not configured; or
## if absThreshCSI-RS-Consolidation in the associated measObject is not configured; or
## if the highest beam measurement quantity value is below or equal to absThreshCSI-RS-Consolidation:
## # derive each cell measurement quantity based on applicable CSI-RS resources for the cell as the highest beam measurement quantity value;
## else:
## # derive each cell measurement quantity based on CSI-RS as the linear power scale average of the highest beam measurement quantity values above absThreshCSI-RS-Consolidation where the total number of averaged beams shall not exceed nrofCSI-RS-ResourcesToAverage;
## apply layer 3 cell filtering.

The IE MeasObjectNR specifies information applicable for SS/PBCH block(s) intra/inter-frequency measurements and/or CSI-RS intra/inter-frequency measurements.

| | |
|---|---|
| nrofSS-BlocksToAverage | INTEGER (2..maxNrofSS- |

BlocksToAverage)

Number of SS blocks to average for cell measurement derivation.
absThreshSS-BlocksConsolidation ThresholdNR

Threshold for consolidation of L1 measurements per RS index.

| | |
|---|---|
| nrofCSI-RS-ResourcesToAverage | INTEGER (2..maxNrofCSI-RS- |

ResourcesToAverage)

Indicates the maximum number of measurement results per beam based on CSI-RS resources to be averaged. The same value applies for each detected cell associated with this MeasObjectNR.
absThreshCSI-RS-Consolidation ThresholdNR

Absolute threshold for the consolidation of measurement results per CSI-RS resource(s) from L1 filter(s). The field is used for the derivation of cell measurement results and the reporting of beam measurement information per CSI-RS resource.

Each serving cell may be configured with a servingCellMO. It is measObjectId of the MeasObjectNR in MeasConfig which is associated to the serving cell.

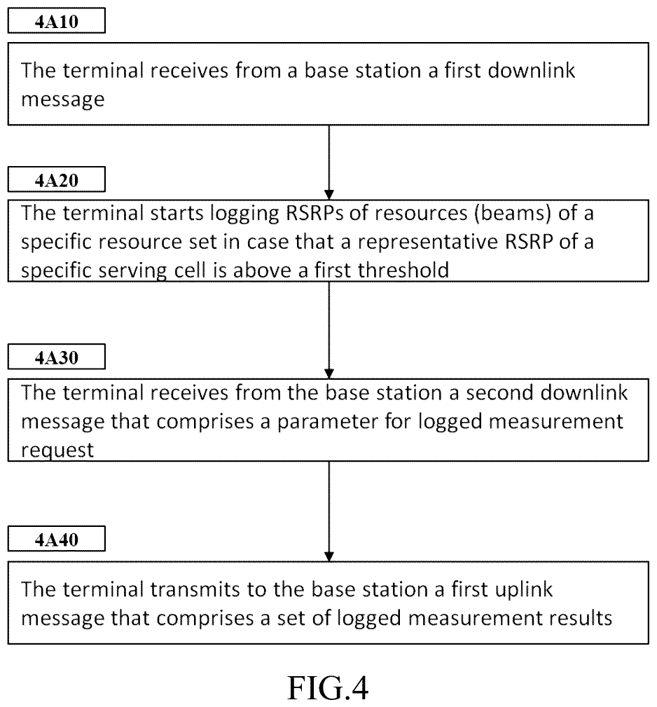

FIG. 4 is a flow diagram illustrating an operation of a terminal.

At 4A10, the terminal receives from a base station a first downlink message, wherein the first downlink message comprises a set of parameters for measurement logging.

At 4A20, the terminal starts logging RSRPs of resources (beams) of a specific resource set at a regular time interval in case that a representative RSRP of a specific serving cell is above/below a first/second threshold during a specific time duration.

At 4A30, the terminal receives from the base station a second downlink message that comprises a parameter for logged measurement request.

At 4A40, the terminal transmits to the base station a first uplink message in response to the second downlink message, wherein the first uplink message comprises a set of logged measurement results and an indication on availability of logged data.

The set of parameters for measurement logging comprises:
>: a parameter for logging resource;
>: a parameter for logging periodicity;
>: a parameter for logging event;
>: a parameter for a first threshold;
>: a parameter for time to trigger.

The serving cell is determined based on a cell where the set of parameters for measurement logging is received.

The specific resource set is determined based on the parameter for logging resource.

The regular time interval is determined based on the parameter for logging periodicity.

The specific time duration is determined based on the parameter for time to trigger.

The representative RSRP of the serving cell is calculated based on weighted moving average of RSRPs of plurality of resources of the serving cell; and

The weighted moving average of RSRP of each resource is calculated over two or more RSRPs of the resource measured at different time points.

A logged measurement result of the set of logged measurement results comprises a parameter indicative of time distance between current measurement and previous measurement.

The logged measurement result of the plurality of logged measurement results further comprises:
>: a plurality of Layer 1-RSRPs; and
>: a plurality of Resource Identifiers.

The terminal stops logging of the RSRP of the resource in case that a radio link failure occurs in a specific cell.

The terminal stops logging of the RSRP of the resource in case that a bandwidth part switching occurs.

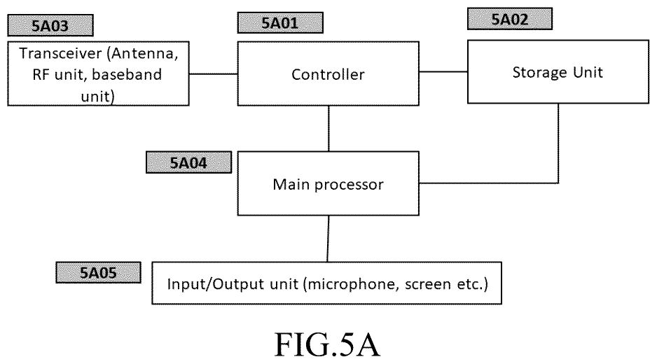

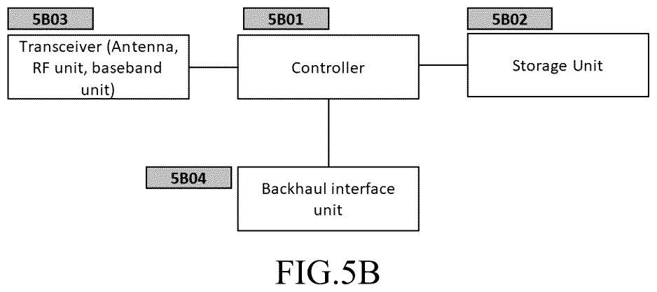

FIG. 5A is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

FIG. 5B is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation in the present disclosure.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to determine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

1. A method performed by a terminal, the method comprising:
receiving, by the terminal, from a base station, a first downlink message, wherein the first downlink message comprises a set of parameters for measurement logging;
starting, by the terminal, logging Reference Signal Reception Power (RSRP) of one or more resources of a second resource set at a regular time interval in case that a representative RSRP of a first resource set is above a first threshold during a specific time duration, wherein the representative RSRP of the first resource set is calculated based on weighted moving-averaged RSRPs of a plurality of resources in the first resource set;
receiving, by the terminal, from the base station, a second downlink message that comprises a parameter for logged measurement request; and
transmitting, by the terminal, to the base station, a first uplink message in response to the second downlink message, wherein the first uplink message comprises a set of logged measurement results and an indication of availability of logged data.

2. The method of claim 1,
wherein the set of parameters for measurement logging comprises:
a parameter for logging resource;
a parameter for logging periodicity;
a parameter for logging event;
a parameter for the first threshold; and
a parameter for time-to-trigger.

3. The method of claim 2, wherein:
the first resource set is determined based on a cell where the set of parameters for measurement logging is received; and
the second resource set is determined based on the parameter for logging resource.

4. The method of claim 3, wherein:
the regular time interval is determined based on the parameter for logging periodicity; and
the specific time duration is determined based on the parameter for time-to-trigger.

5. The method of claim 3, wherein
the weighted moving-averaged RSRP of each resource of the plurality of the resources is calculated over two or more RSRPs of the resource measured at different time points.

6. The method of claim 1, wherein:
a logged measurement result of the set of logged measurement results comprises a parameter indicative of a time distance between a current measurement and a previous measurement.

7. The method of claim 6,
wherein the logged measurement result of the set of logged measurement results further comprises:
a plurality of Layer 1-RSRPs; and
a plurality of Resource Identifiers.

8. The method of claim 1,
wherein the terminal stops logging of the RSRP of the one or more resources in case that a radio link failure occurs in a specific cell.

9. The method of claim 1,
wherein the terminal stops logging of the RSRP of the one or more resources in case that a bandwidth part switching occurs.

10. The method of claim 1, further comprising:
receiving, by the terminal, from the base station, a third downlink message that comprises the parameter for logged measurement request; and
transmitting, by the terminal, to the base station, a second uplink message in response to the third downlink message, wherein the second uplink message comprises a second set of logged measurement results.

11. A terminal in a wireless communication system, the terminal comprising:
a transceiver configured to transmit and receive signals, and
a controller configured to control the transceiver to:
receive, from a base station, a first downlink message, wherein the first downlink message comprises a set of parameters for measurement logging;
start logging Reference Signal Reception Power (RSRP) of one or more resources of a second resource set at a regular time interval in case that a representative RSRP of a first resource set is above a first threshold during a specific time duration, wherein the representative RSRP of the first resource set is calculated based on weighted moving-averaged RSRPs of a plurality of resources in the first resource set;
receive, from the base station, a second downlink message that comprises a parameter for logged measurement request; and
transmit, to the base station, a first uplink message in response to the second downlink message, wherein the first uplink message comprises a set of logged measurement results and an indication of availability of logged data.
